(19) United States
(12) Patent Application Publication
(10) Pub. No.: US 2024/0345936 A1
(43) Pub. Date: Oct. 17, 2024

(54) Dataflow Graph Performance Debugger And Design Rule Checker For CGRA

(71) Applicant: SambaNova Systems, Inc., Palo Alto, CA (US)

(72) Inventors: Muthiah ANNAMALAI, Hayward, CA (US); Anders RAVNBORG, Palo Alto, CA (US)

(73) Assignee: SambaNova Systems, Inc., Palo Alto, CA (US)

(21) Appl. No.: 18/632,236

(22) Filed: Apr. 10, 2024

Related U.S. Application Data
(60) Provisional application No. 63/458,425, filed on Apr. 10, 2023.

(51) Int. Cl. G06F 11/34; G06F 11/36

(52) U.S. Cl. CPC G06F 11/3452; G06F 11/3428; G06F 11/3616

(57) ABSTRACT

A system comprising a tool for providing actionable insight for bring up and performance debug of performant dataflow graphs on CGRA. A system comprising a tool for providing hierarchical traceable graph transformation of dataflow graph and annotated with runtime information after the compilation and execution back onto higher levels of stack from hardware metrics. A system comprising a tool for system performance monitoring and tuning by composition of compile time and runtime information of a workload dataflow graph on CGRA.

### PRIORITY APPLICATION

This application claims the benefit of and priority to U.S. Provisional Patent Application No.: 63/458,425, titled “Dataflow Graph Performance Debugger and Design Rule Checker for CGRA,” filed Apr. 10, 2023 (Attorney Docket No. SBNV1175USP01).

### CROSS-REFERENCES AND INCORPORATIONS

This application is related to the following commonly owned applications:
U.S. Provisional Patent Application No. 63/458,315, entitled, “Intelligent Graph Execution and Orchestration Engine for a Reconfigurable Data Processor,” filed on 10 Apr. 2023.
U.S. Provisional Patent Application No. 63/458,305, entitled, “Debugging Framework For A Reconfigurable Data Processor,” filed on 10 Apr. 2023.

This application is related to the following published documents:
Prabhakar et al., “Plasticine: A Reconfigurable Architecture for Parallel Patterns,” ISCA '17, Jun. 24-28, 2017, Toronto, ON, Canada; and
Koeplinger et al., “Spatial: A Language and Compiler for Application Accelerators,” Proceedings of the 39th ACM SIGPLAN Conference on Programming Language Design and Implementation (PLDI), Proceedings of the 43rd International Symposium on Computer Architecture, 2018.

The related application(s) and other documents listed above are hereby incorporated by reference in their entirety herein for any and all purposes.

### BACKGROUND

### Technical Field

The present subject matter relates to a debugging and performance tuning tool for a coarse-grained reconfigurable architecture processor.

### Context

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

Coarse grain reconfigurable architectures (CGRAs) exhibit far superior performance over conventional architectures, such as field programmable gate arrays (FPGAs) as they provide the capability to execute applications as nested dataflow pipelines. Maximizing the utilization of compute units in the CGRA to perform useful computations is critical to harness the benefits of a CGRA. A challenge to increasing compute unit (e.g., arithmetic logic unit (ALU)) utilization is to provide input data to the compute units at high enough bandwidth to sustain high compute throughput. CGRAs typically have memories organized in a distributed grid on-chip. Providing data at high throughput to compute units thus involves generating memory addresses at high throughput.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings, in which.

The technology will be described with reference to the drawings, in which:

FIG. 1A is a high-level block diagram showing how an implementation of SambaTune can interact with the compiler and runtime elements in a system.

FIG. 1B shows an example SambaTune Workflow.

FIG. 1C shows an iterative SambaTune Workflow.

FIG. 2 shows an example Host-Device latency split report from an implementation of SambaTune.

FIGS. 3A and 3B shows example section reports from an implementation of SambaTune.

FIG. 4 shows an example stage report from an implementation of SambaTune.

FIG. 5 shows a flowchart for identifying workload bottlenecks.

FIGS. 6A-6N provide an overview of the use of SambaTune in a CGRA processor.

FIGS. 7A-7N show example screenshots of the user interface for SambaTune.

FIGS. 8A-8C is a table showing example fields that may be reported in SambaTune reports.

FIG. 9 shows example idioms and design rules for an implementation of SambaTune.

FIGS. 10A-10I show elements of a hierarchical debug using SambaTune.

FIG. 11 illustrates an example system including a coarse-grained reconfigurable (CGR) processor, a host, and a memory.

FIG. 12 illustrates an example of a computer, including an input device, a processor, a storage device, and an output device.

FIG. 13 illustrates example details of a CGR architecture including a top-level network (TLN) and two CGR arrays.

FIG. 14 illustrates an example CGR array, including an array of CGR units in an array-level network (ALN).

FIG. 15 illustrates an example of a pattern memory unit (PMU) and a pattern compute unit (PCU), which may be combined in a fused-control memory unit (FCMU).

FIG. 16 is a block diagram of a compiler stack implementation suitable for generating a configuration file for a CGR processor.

FIG. 17 shows an example user program in an example first stage of the compiler stack.

FIG. 18 shows the user program in an example second stage of the compiler stack.

FIG. 19 shows the user program in an example third stage of the compiler stack.

FIG. 20 shows the user program in an example fourth stage of the compiler stack.

FIG. 21 shows the logical computation graph and an example physical layout of the user program.

In the figures, like reference numbers may indicate functionally similar elements. The systems and methods illustrated in the figures, and described in the Detailed Description below, may be arranged and designed in a wide variety of different implementations. Neither the figures nor the Detailed Description are intended to limit the scope of the claims. Instead, they merely represent examples of different implementations of the disclosed technology.

### DETAILED DESCRIPTION

SambaTune is useful for providing a combination of insight (using graphs at each level of compiler transformation, performance counters, and measured utilization on CGRA and DDR on-board performance, and other metrics) in combination with a recommendation design-rule-checker engine forms. This allows for speedup of identifying performance bottlenecks in CGRA as well as iterated design workflow to onboard dataflow models. It provides the following features:
Profiling and Diagnostic Tool
Provides observability into system performance of ML/HPC applications.
Highlights compute and communication bottlenecks.
Provides browser-based GUI for visual analysis.
Allows experiment tracking and comparison.
Provides tuning recommendations.

Traditional compilers translate human-readable computer source code into machine code that can be executed on a Von Neumann computer architecture. In this architecture, a processor serially executes instructions in one or more threads of software code. The architecture is static, and the compiler does not determine how execution of the instructions is pipelined, or which processor or memory takes care of which thread. Thread execution is asynchronous, and safe exchange of data between parallel threads is not supported.

High-level programs for machine learning (ML) and artificial intelligence (AI) may require massively parallel computations, where many parallel and interdependent threads (metapipelines) exchange data. Such programs are ill-suited for execution on Von Neumann computers. They require architectures that are optimized for parallel processing, such as coarse-grained reconfigurable (CGR) architectures (CGRAs) or graphic processing units (GPUS). The ascent of ML, AI, and massively parallel architectures places new requirements on compilers, including how computation graphs, and in particular dataflow graphs, are pipelined, which operations are assigned to which compute units, how data is routed between various compute units and memory, and how synchronization is controlled particularly when a dataflow graph includes one or more nested loops, whose execution time varies dependent on the data being processed.

### Terminology

As used herein, the phrase one of should be interpreted to mean exactly one of the listed items. For example, the phrase “one of A, B, and C” should be interpreted to mean any of: only A, only B, or only C.

As used herein, the phrases at least one of and one or more of should be interpreted to mean one or more items. For example, the phrase “at least one of A, B, or C” or the phrase “one or more of A, B, or C” should be interpreted to mean any combination of A, B, and/or C. The phrase “at least one of A, B, and C” means at least one of A and at least one of B and at least one of C.

Unless otherwise specified, the use of ordinal adjectives first, second, third, etc., to describe an object, merely refers to different instances or classes of the object and does not imply any ranking or sequence.

The terms comprising and consisting have different meanings in this patent document. An apparatus, method, or product “comprising” (or “including”) certain features means that it includes those features but does not exclude the presence of other features. On the other hand, if the apparatus, method, or product “consists of” certain features, the presence of any additional features is excluded.

The term coupled is used in an operational sense and is not limited to a direct or an indirect coupling. “Coupled to” is generally used in the sense of directly coupled, whereas “coupled with” is generally used in the sense of directly or indirectly coupled. “Coupled” in an electronic system may refer to a configuration that allows a flow of information, signals, data, or physical quantities such as electrons between two elements coupled to or coupled with each other. In some cases, the flow may be unidirectional, in other cases the flow may be bidirectional or multidirectional. Coupling may be galvanic (in this context meaning that a direct electrical connection exists), capacitive, inductive, electromagnetic, optical, or through any other process allowed by physics.

The term connected is used to indicate a direct connection, such as electrical, optical, electromagnetic, or mechanical, between the things that are connected, without any intervening things or devices.

The term configured (to perform a task or tasks) is a broad recitation of structure generally meaning “having circuitry that” performs the task or tasks during operation. As such, the described item can be configured to perform the task even when the unit/circuit/component is not currently on or active. In general, the circuitry that forms the structure corresponding to “configured to” may include hardware circuits, and may further be controlled by switches, fuses, bond wires, metal masks, firmware, and/or software. Similarly, various items may be described as performing a task or tasks, for convenience in the description. Such descriptions should be interpreted as including the phrase “configured to.” Reciting an item that is configured to perform one or more tasks is expressly intended not to invoke 35 U.S.C. 112, paragraph (f) interpretation for that unit/circuit/component. More generally, the recitation of any element is expressly intended not to invoke 35 U.S.C. § 112, paragraph (f) interpretation for that element unless the language “means for” or “step for” is specifically recited.

As used herein, the term based on is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an implementation in which A is determined based solely on B. The phrase “based on” is thus synonymous with the phrase “based at least in part on.”

The following terms or acronyms used herein are defined at least in part as follows:

AGCU—address generator (AG) and coalescing unit (CU).

AI—artificial intelligence.

AIR—arithmetic or algebraic intermediate representation.

ALN—array-level network.

Buffer—an intermediate storage of data.

CGR—coarse-grained reconfigurable. A property of, for example, a system, a processor, an architecture (see CGRA), an array, or a unit in an array. This property distinguishes the system, etc., from field-programmable gate arrays (FPGAs), which can implement digital circuits at the gate level and are therefore fine-grained configurable.

CGRA—coarse-grained reconfigurable architecture. A data processor architecture that includes one or more arrays (CGR arrays) of CGR units.

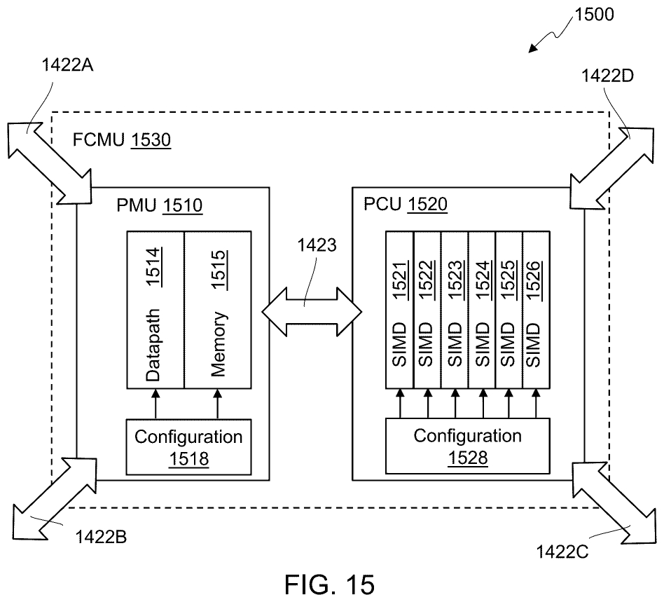

Compiler—a translator that processes statements written in a programming language to machine language instructions for a computer processor. A compiler may include multiple stages to operate in multiple steps. Each stage may create or update an intermediate representation (IR) of the translated statements. Compiler stages are illustrated with reference to FIG. 15.

Computation graph—some algorithms can be represented as computation graphs. As used herein, computation graphs are a type of directed graphs comprising nodes that represent mathematical operations/expressions and edges that indicate dependencies between the operations/expressions. For example, with machine learning (ML) algorithms, input layer nodes assign variables, output layer nodes represent algorithm outcomes, and hidden layer nodes perform operations on the variables. Edges represent data (e.g., scalars, vectors, tensors) flowing between operations. In addition to dependencies, the computation graph reveals which operations and/or expressions can be executed concurrently.

CGR unit—a circuit that can be configured and reconfigured to locally store data (e.g., a memory unit or a PMU), or to execute a programmable function (e.g., a compute unit or a PCU). A CGR unit includes hardwired functionality that performs a limited number of functions used in computation graphs and dataflow graphs. Further examples of CGR units include a CU and an AG, which may be combined in an AGCU. Some implementations include CGR switches, whereas other implementations may include regular switches.

CU—coalescing unit.

Dataflow Graph—a computation graph that includes one or more loops that may be nested, and wherein nodes can send messages to nodes in earlier layers to control the dataflow between the layers.

Datapath—a collection of functional units that perform data processing operations. The functional units may include memory, multiplexers, ALUs, SIMDs, multipliers, registers, buses, etc.

FCMU—fused compute and memory unit—a circuit that includes both a memory unit and a compute unit.

Graph—a collection of nodes connected by edges. Nodes may represent various kinds of items or operations, dependent on the type of graph. Edges may represent relationships, directions, dependencies, etc.

IC—integrated circuit—a monolithically integrated circuit, i.e., a single semiconductor die which may be delivered as a bare die or as a packaged circuit. For the purposes of this document, the term integrated circuit also includes packaged circuits that include multiple semiconductor dies, stacked dies, or multiple-die substrates. Such constructions are now common in the industry, produced by the same supply chains, and for the average user often indistinguishable from monolithic circuits.

A logical CGR array or logical CGR unit—a CGR array or a CGR unit that is physically realizable, but that may not have been assigned to a physical CGR array or to a physical CGR unit on an IC.

Metapipeline—a subgraph of a computation graph that includes a producer operator providing its output as an input to a consumer operator to form a pipeline. A metapipelines may be nested within another metapipeline, that is, producer operators and consumer operators may include other metapipelines.

ML—machine learning.

PCU—pattern compute unit—a compute unit that can be configured to repetitively perform a sequence of operations.

PEF—processor-executable format—a file format suitable for configuring a configurable data processor.

Pipeline—a staggered flow of operations through a chain of pipeline stages. The operations may be executed in parallel and in a time-sliced fashion. Pipelining increases overall instruction throughput. CGR processors may include pipelines at different levels. For example, a compute unit may include a pipeline at the gate level to enable correct timing of gate-level operations in a synchronous logic implementation of the compute unit, and a metapipeline at the graph execution level (typically a sequence of logical operations that are to be repetitively executed) that enables correct timing and loop control of node-level operations of the configured graph. Gate-level pipelines are usually hard wired and unchangeable, whereas metapipelines are configured at the CGR processor, CGR array level, and/or GCR unit level.

Pipeline Stages—a pipeline is divided into stages that are coupled with one another to form a pipe topology.

PMU—pattern memory unit—a memory unit that can locally store data according to a programmed pattern.

PNR—place and route—the assignment of logical CGR units and associated processing/operations to physical CGR units in an array, and the configuration of communication paths between the physical CGR units.

RAIL—reconfigurable dataflow unit (RDU) abstract intermediate language.

CGR Array—an array of CGR units, coupled with each other through an array-level network (ALN), and coupled with external elements via a top-level network (TLN). A CGR array can physically implement the nodes and edges of a dataflow graph.

SIMD—single-instruction multiple-data—an arithmetic logic unit (ALU) that simultaneously performs a single programmable operation on multiple data elements delivering multiple output results.

TLIR—template library intermediate representation.

TLN—top-level network.

### Implementations

SambaTune is an observability tool for viewing and tuning workload performance on SambaNova DataScale systems. The tool provides features for profiling ML workloads, collecting and displaying diagnostic data, highlighting potential bottlenecks, providing analysis for actionable insights and recommendations for tuning. The tool offers features to sweep parameters and highlights the optimal configurations. The tool provides options to compare runs and displays the difference in metrics between the selected runs. The tool also has the capability to tune workloads automatically.

### SambaTune Use Cases

1) Performance profiling with tool features that enable a user to collect diagnostic data including but not limited to execution timelines, on-chip and off-chip memory usage, compute utilization, occupancy and activity, on-chip and off-chip bandwidth.
2) Performance analysis with tool features that guide the user to the top bottlenecks in the workload
3) Performance tuning recommendations that enable the user to decide what action(s) (for e.g.: next configuration of the application to run and profile) to take based on the analysis
4) Autotune workloads based on architecture specific design rules.

### Key Differentiators

One stop solution for identifying and diagnosing performance bottlenecks (memory, bandwidth, compute) and providing tuning recommendations
Interactive Visualization with tool features to sort, search, filter in tables and charts, expand, collapse, zoom, pan (graphs) with data in tabular, chart or graph form. The visualizer provides the ability to associate a higher level metric to a lower level counter by hyperlinking charts, tables and graphs in a hierarchical manner. This provides the user with a global context while analyzing local hotspots.
Compare runs and understand cause-effect
Tuning recommendations to guide the user to the next set of experiments
Parameter Sweep
Allows the user to sweep configuration parameters to find optimal settings
Smart tune
Hybrid Design Rule and Recommendation Learning based auto-tuning of workloads

Characterizing a workload is the act of identifying bottlenecks which involves finding the critical path in the workload. The latency of the critical path sets the upper bound of the throughput of the workload, and therefore, improving the latency of this critical path has a higher probability of resulting in improved performance than optimizing non-critical paths.

Here are some of the bottlenecks that may limit the maximum achievable performance:
1. Host boundedness
2. Accelerator Resource boundedness
3. Accelerator Memory boundedness
4. Accelerator Bandwidth boundedness

The goal of performance tuning is to experiment with parameters until the workload is compute bound. In other words, when we have maximum use of the hardware resources, and the resources are maximally busy, the accelerator hardware is utilized efficiently and the application reaches its best performance on the hardware. SambaTune collects diagnostic data on the host and the accelerator device, aggregates the metrics and generates reports to aid the understanding of workload boundedness. In the future, SambaTune will be able to do automatic workload characterization and automatic tuning.

SambaTune has the key ability to compare performance of model-graph between (expected) compiler performance model estimates and the (actual) runtime RDU performance estimates. This can be achieved in three steps:
1. First adding instrumentation bread-crumbs into the compiled-graph that manifests into the generated PMU-PCU code on CGRA with ability to report this back when run in the “sentinel”-instrumentation mode.
2. Secondly, we use runtime to capture this instrumented data from the CGRA (RDU) and create a log record of counters (equivalent of stack-pointer and instruction-pointer) in the host.
3. Thirdly SambaTune uses a graph matching algorithm to put together the runtime data on the compiler level intermediate-representation (IR) graph.

Together this “collated report” and algorithm allows compiler estimates to be revised with real-time feedback from ground truth situations. Further, SambaTune can propagate this runtime profile information from lowest level of execution PMU/PCU on RDU to the intermediate levels of representation all the way to the framework level neural operators to estimate their resource utilization, benchmarking etc. This is our claim to provide a genealogy (traceability) of tracking in SambaTune from coarse to fine-grained level.

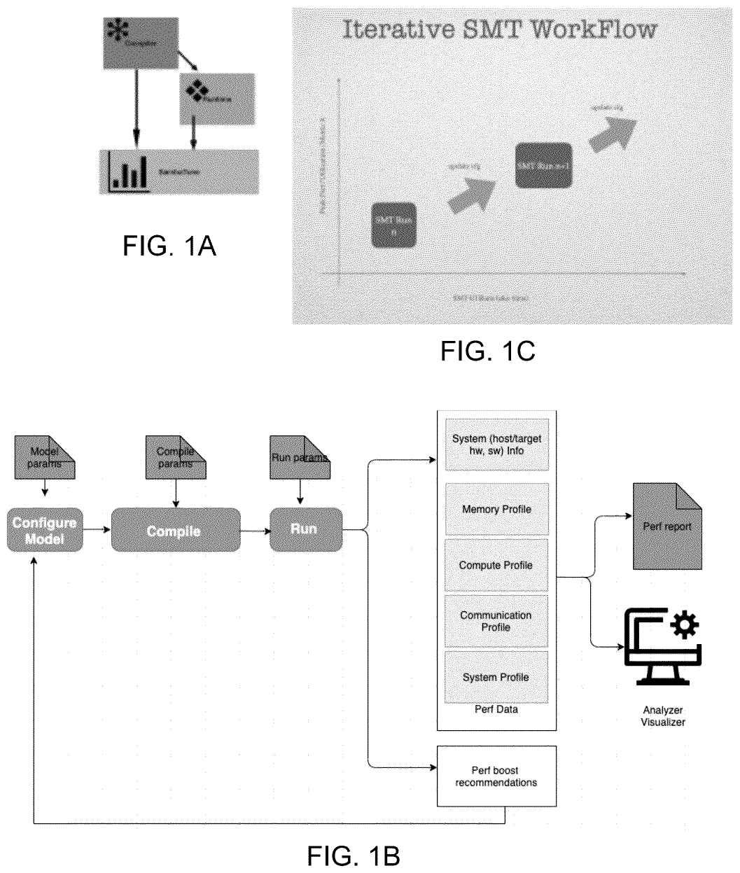

FIG. 1A is a high-level block diagram showing how an implementation of SambaTune can interact with the compiler and runtime elements in a system.

FIG. 1B shows a SambaTune Workflow. The user configures the ML model, compile parameters and run parameters and starts the run. SambaTune will compile the ML model to enable several instrumentation counters and run it multiple times to collect various benchmarking data like average latency, throughput, DDR BW, PCIe BW. The collected data is organized into reports. The reports can be visualized in a web-based browser client that allows for intuitive, context based navigation and interactivity.

What does a SambaTune run do?

SambaTune will compile the application with the user-specified model-args, compile-args and hardware-supported instrumentation flags in order to enable programmable hardware counters to collect performance data when the application executes on the RDU.

After successful compilation, SambaTune will run the application on the RDU and collect performance counter data. It will also run the application in benchmark mode with user-specified run-args to collect latency, throughput and hardware utilization statistics. SambaTune also supports profiling inference and training runs.

At the end of a successful run, SambaTune will collate compile-time and run-time statistics to generate performance reports. A web-based GUI will render the reports contextually to help the user identify potential hotspots.

SambaTune generates logs that capture the status of each step of the run, including individual data collection steps, post processing steps and visualization steps. 3 separate logs are generated:
1. Status_summary.log: This log captures the high level summary of steps executed in the run and the status of each step. This is intended for use to get a quick view of the health of the run.
2. Status_debug.log: This log captures the details of each step of the run. Each step has information about the command that was run, it's status and tracebacks if the step failed. This is intended for use if the user is interested in triaging a failed run and wants to see if there is an opportunity to rerun by changing any input parameters.
3. run.log: This log captures the messages that are streamed to the console as various steps in the tool execute. The messages in the log are captured in the order in which they were streamed to the console. This log has information about whether the compilation was successful and where the individual compile logs can be found, whether the benchmarking, profiling runs succeeded and reasons for failure.

SambaTune can generate several reports. What can be visualized in the user interface?
Host vs RDU time.
Time breakdown on the host.
Section metrics on the device.
Stage metrics on the device.

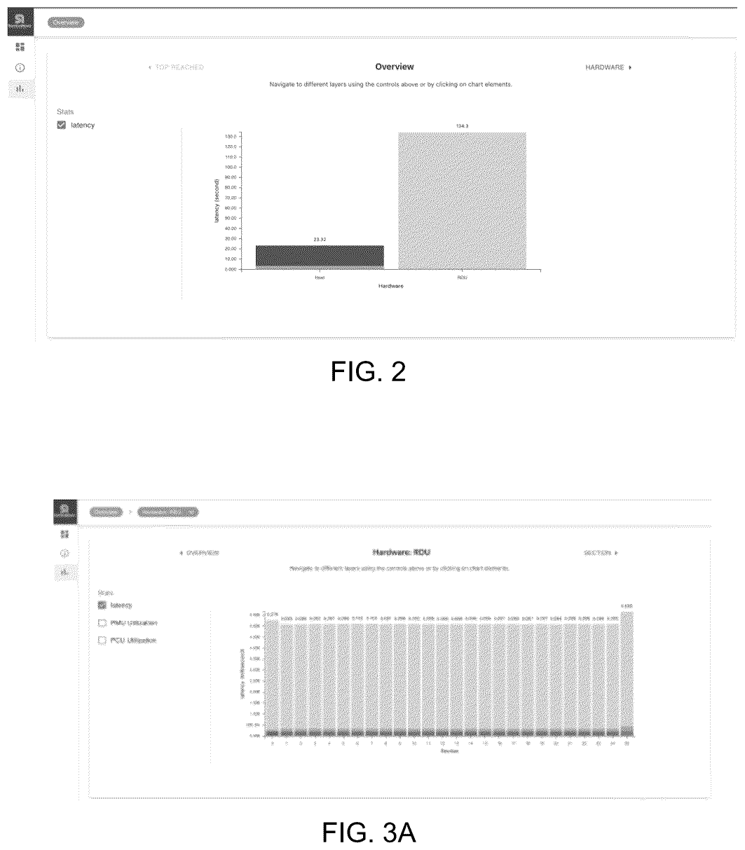

FIG. 2 shows an example Host-Device latency split report. This report provides the initial top-down information about whether the workload is host-bound or RDU bound, i.e., if more time was spent on the host or on the device. In other words, it helps to understand if the accelerator device may be underutilized due to inefficient task dispatch from the host runtime.

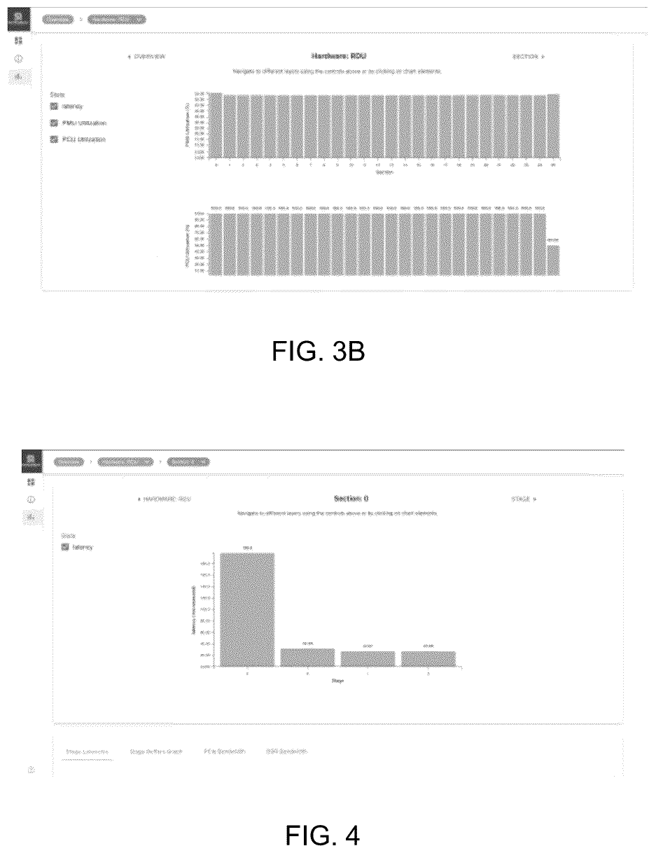

FIGS. 3A and 3B show example section reports. This report provides the next level of information about where on the RDU the workload may be bottlenecked. An ML graph is split into sections and each section is run on an RDU. This report provides per-section diagnostics—it lists the time taken by each section, the resources (PCU, PMU) used by each section and the bandwidth of data transferred in and out for each section (DDR, PCIe). The longest latency section is usually of interest as a region of potential optimizations, but not always So,. If the longest section has high compute utilization (PCU usage>80%) with high bandwidth usage (DDR BW>80 GBps), there may not be much to optimize in this section and other sections need to be analyzed for potential low resource utilization and low bandwidth. If resource utilization is low, manual resource tuning may be attempted with a custom “human decisions” (Add reference to MACs Human Decisions doc, if there is one) file where the PCU parallelization factors and section boundaries can be adjusted.

FIG. 4 shows example Stage reports. This report provides lower-level information about where in an RDU section, a workload may be bottlenecked. A section is split into stages. This report provides per-stage diagnostics—it lists the time taken by each stage. A stage is often the equivalent of an ML graph operator, but not always So,. A stage may be an intermediate buffer inserted by the compiler mid-end or backend, or multiple operators may be fused into one stage. Stages execute as a pipeline, and therefore, the longest latency stage is often the critical stage, but not always So,. Stage latencies are affected by the time taken to execute the operations in the stage, the bandwidth of data flowing into this stage from the previous stage (producer) and the bandwidth and available capacity of the next stage to consume the outputs of this stage (consumer). Therefore, a stage that is bandwidth bound may be the bottleneck instead of the longest latency stage.

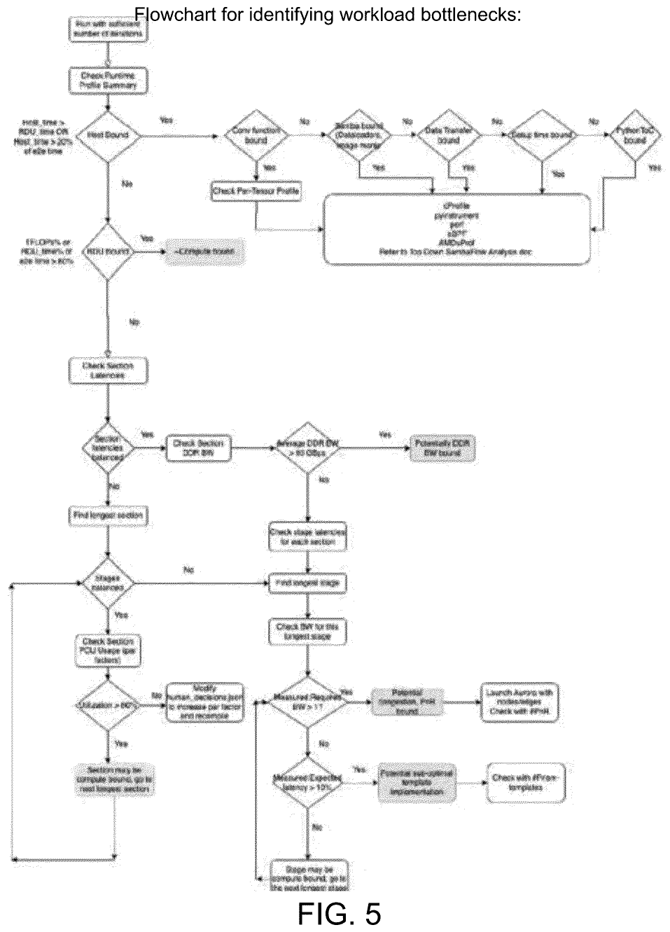

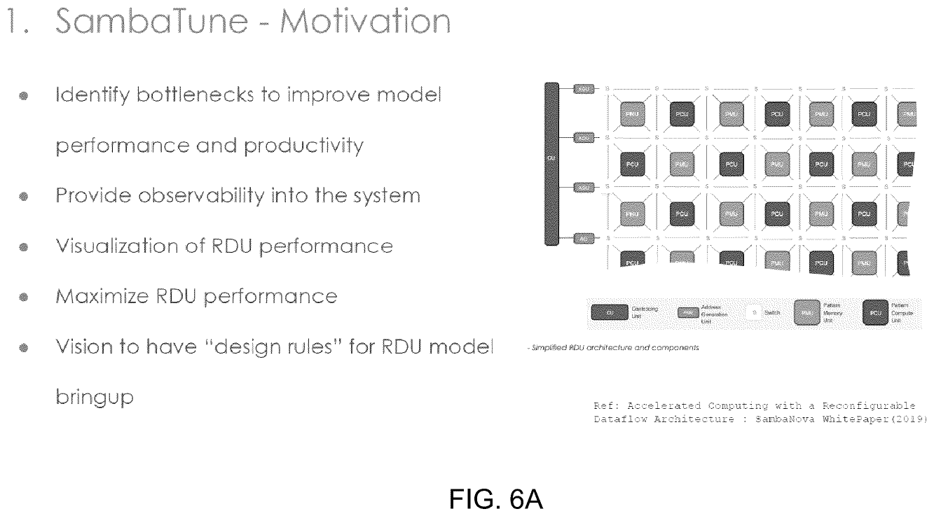

FIG. 5 shows a flowchart for identifying workload bottlenecks. To enable the customer to identify performance bottlenecks in their workloads, we provide a top-down analysis workflow via a GUI. The UI will help the user navigate to the hotspots in a hierarchical manner—from the python application to the library implementation of operations in an ML graph. Through visual charts and interactive tabular data, the user is enabled to spot problem areas quickly and effectively.

In order to enable the user to do top level performance analysis, we need to address the following questions:
1. What info does the user have access to?
2. What do we want the user to do with access to this info before making a support call request to SN?

What info does the user have access to? With SambaTune, the user has access to:
1. Execution time on host, RDU
   a. Execution time on host includes time spent on the host to set up and transfer data to and from the RDU over PCIe
   b. Execution time on the RDU includes time spent on the RDU to execute the operations in the graph, load and store data to and from the device DRAM
2. PCU, PMU Resources used on the RDU
3. RDU-DRAM Data transfer bandwidth, RDU-Host PCIe bandwidth

What does SambaTune allow the user to do?
1. Identify if the workload is host bound or RDU bound. Host Time>RDU time.
   a. Ideally, the time spent on the host should be <=5% of the e2e time.
   b. Practically, an untuned application may be spending anything between 20-90% of the time on the host
2. If Host time>RDU time, review the snprof details to know how time is spent on the host, identify the top 3 reasons impacting execution time
   a. Transferring data
      i. Setting and getting tensors to and from the RDU
         1. What are the top 3 tensors (and their % share of the time) contributing to this time?
         2. What are their shapes and sizes and number?
      ii. Input arguments sent to the RDU
         1. What are the top 3 arguments (and their % share of the time) contributing to this time?
         2. What are their attributes?
   b. Converting tensors from one format or layout to another
      i. Fp32 to bfloat16 and back?
      ii. CVRM, RVCM and other combinatorial layouts?
      iii. Vector alignments
      iv. Vector Transpose
   c. Setting up the RDU for creating a session
   d. Setting up the device DRAM for DMA
   e. Python to C conversion
      i. This includes time spent in the host in Python to C translation

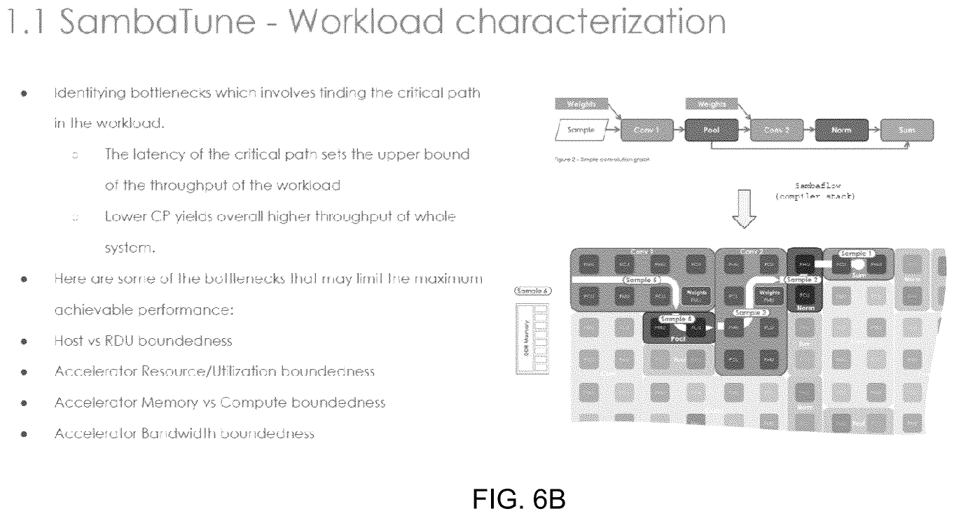

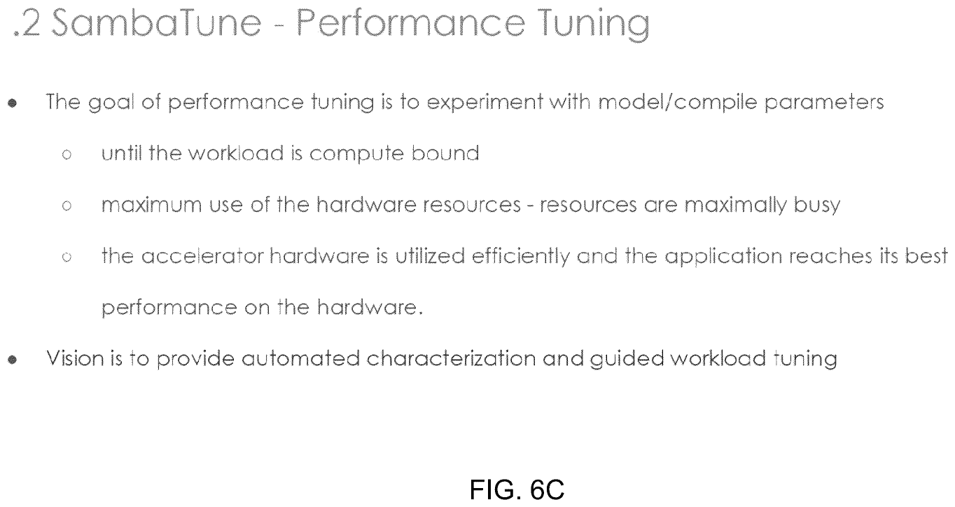

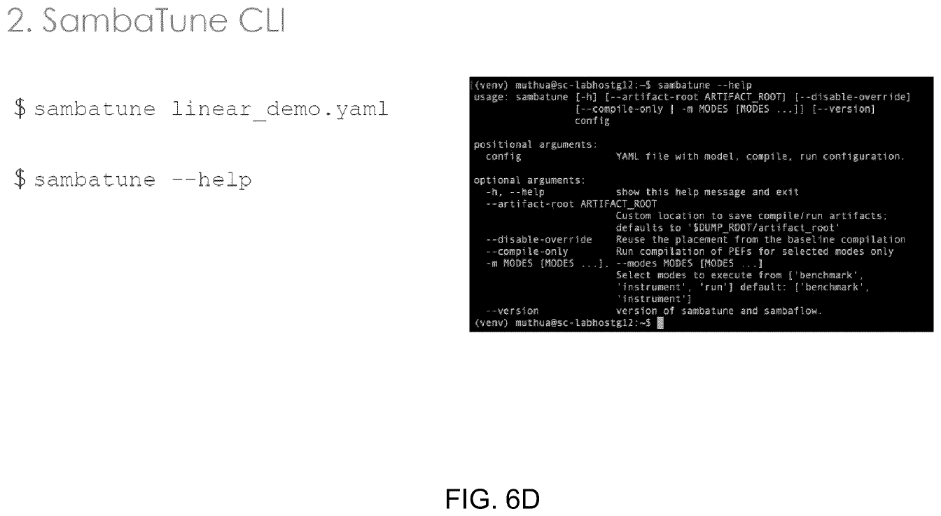

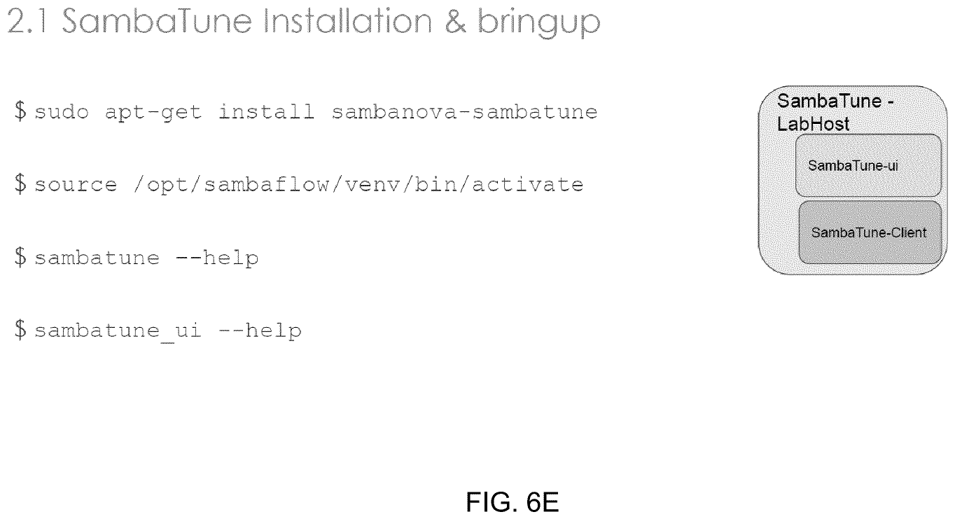

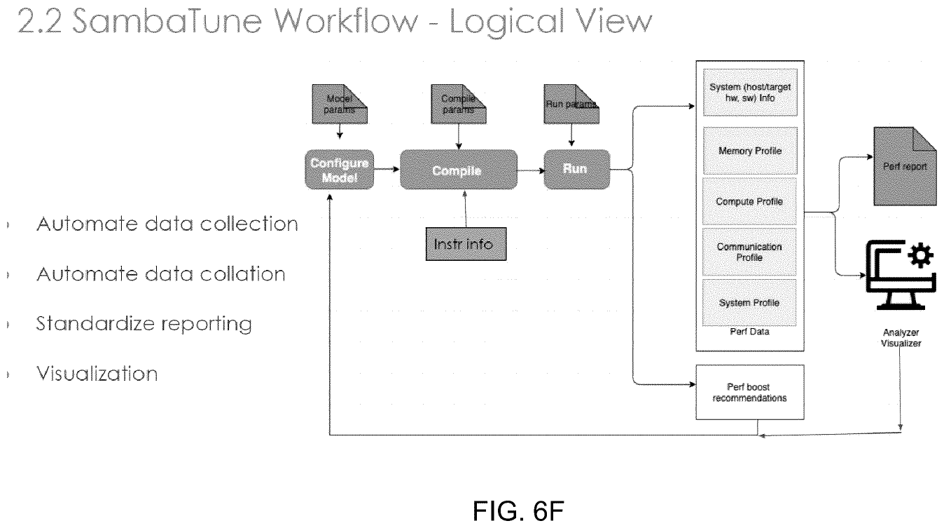

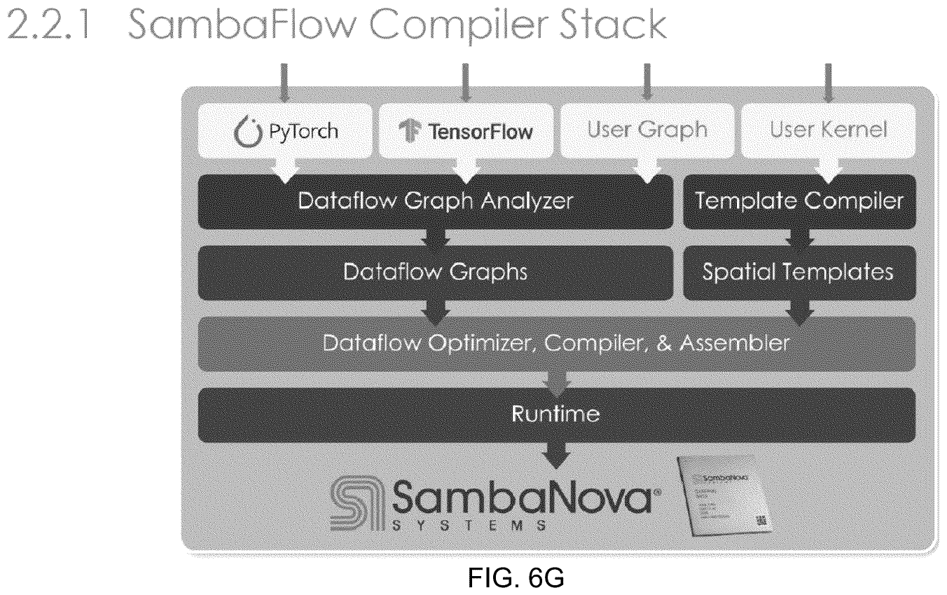

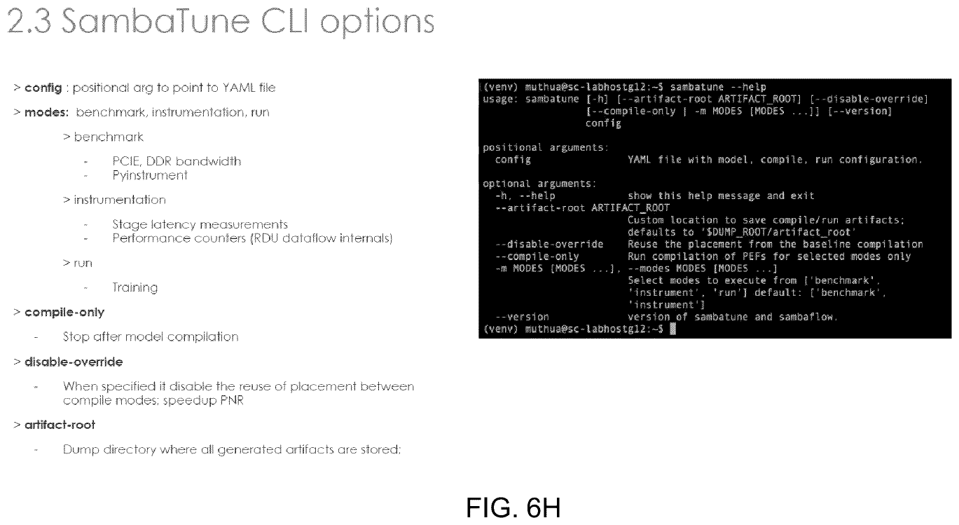

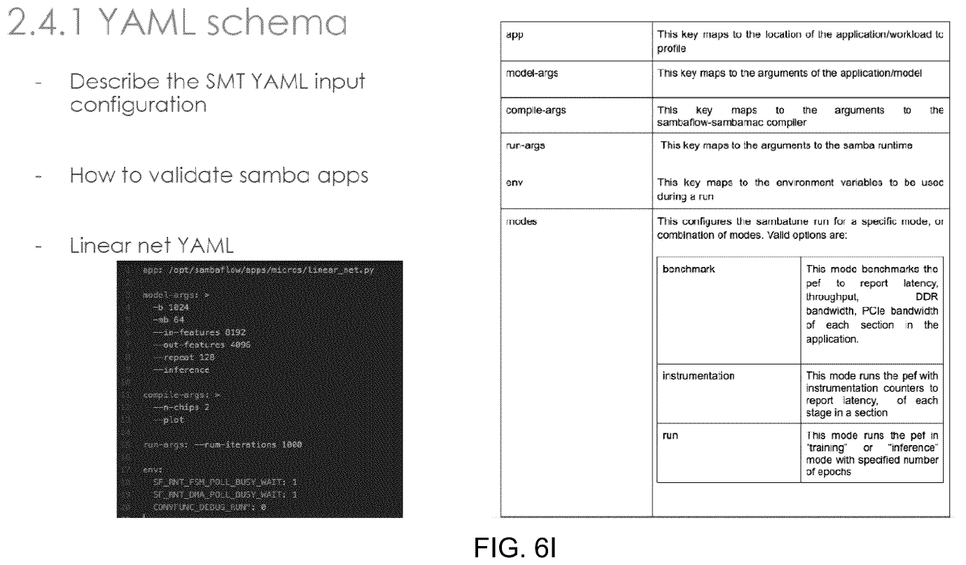

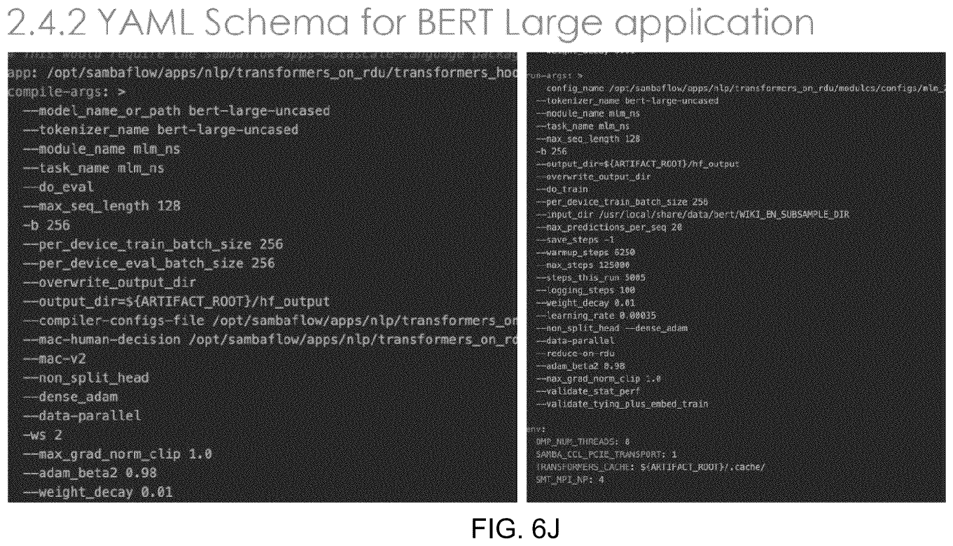

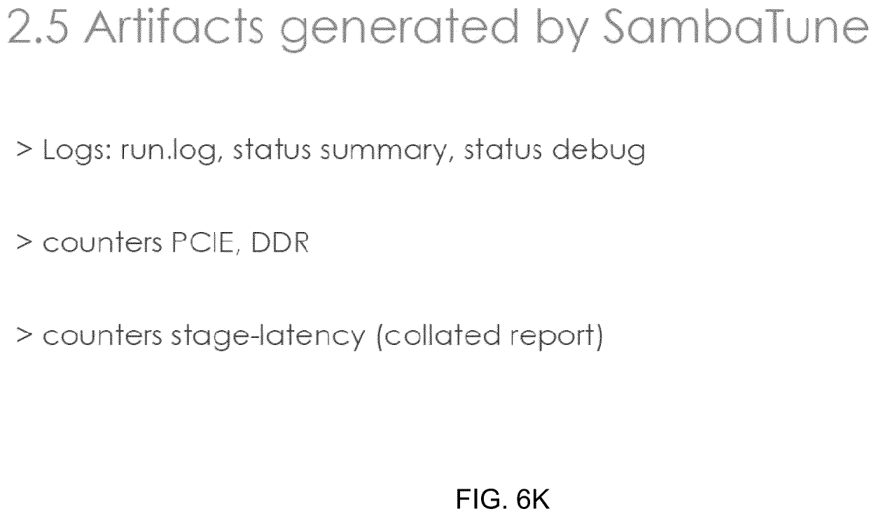

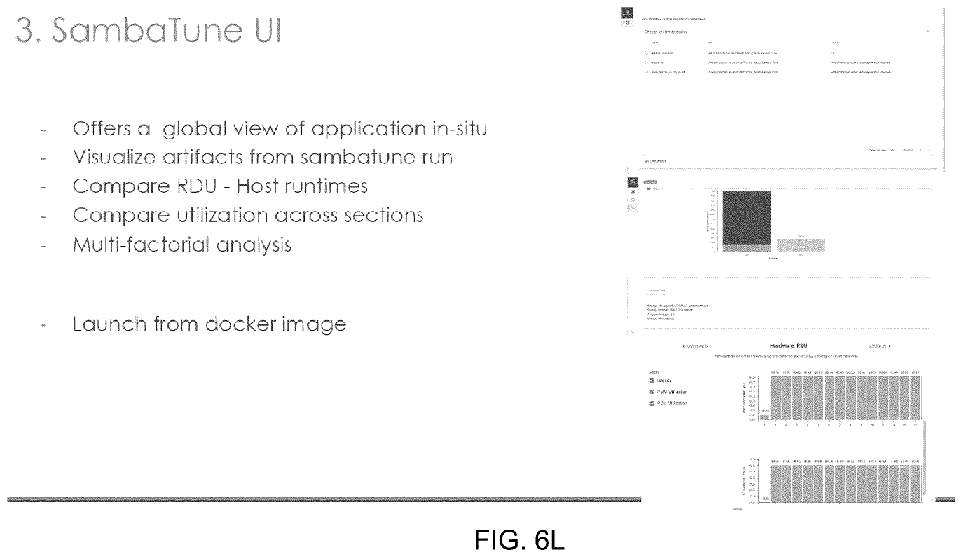

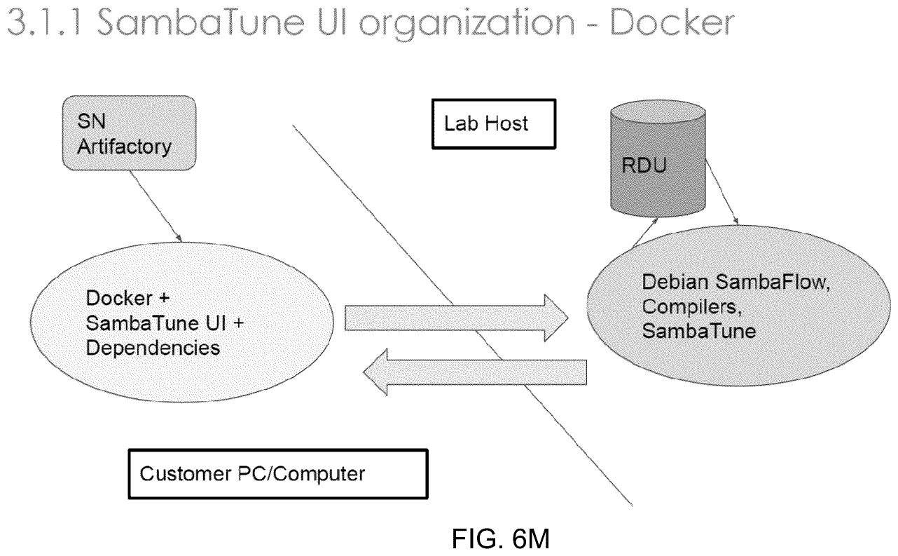

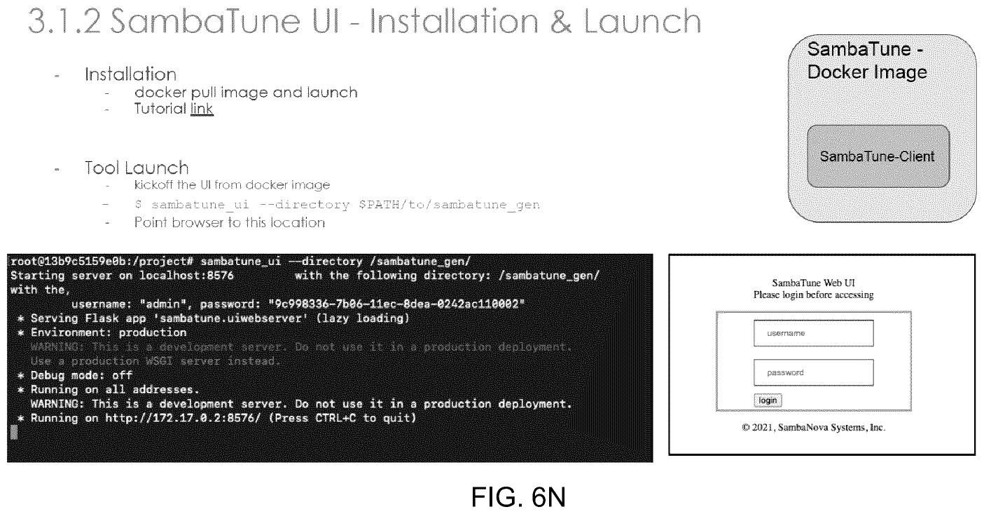

FIGS. 6A-6N provide an overview of the use of SambaTune in a CGRA processor.

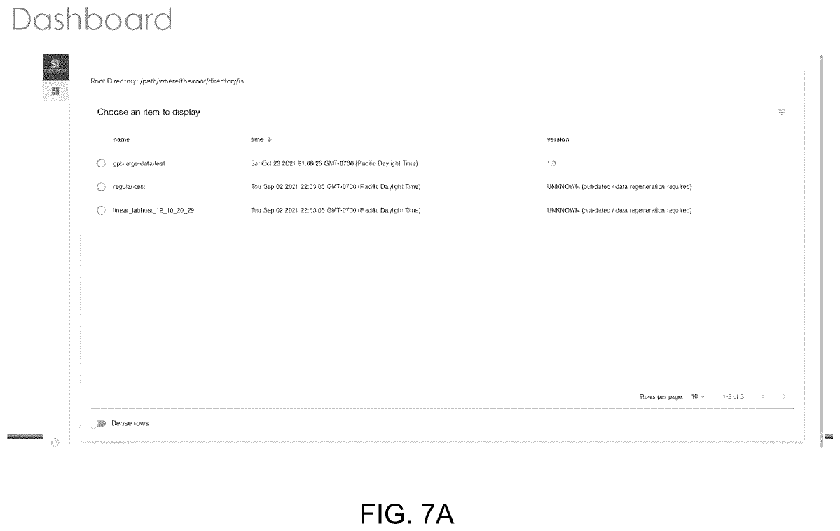

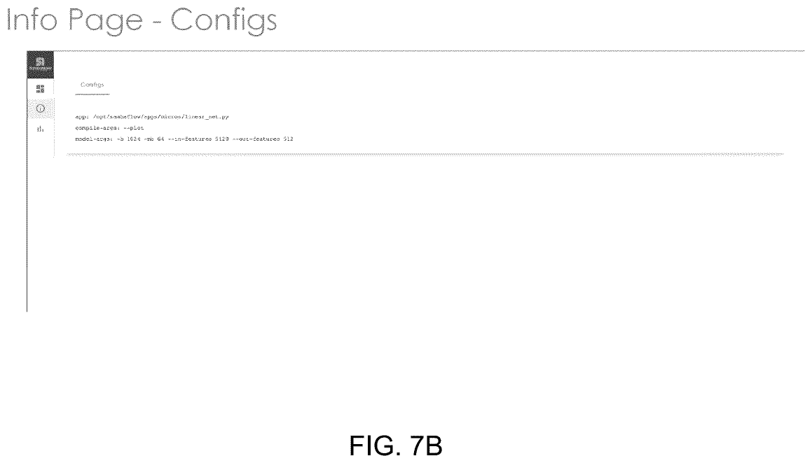

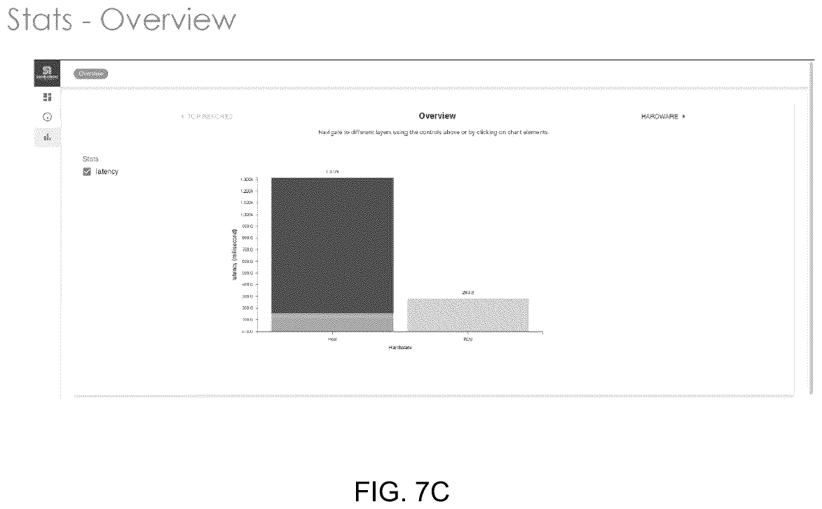

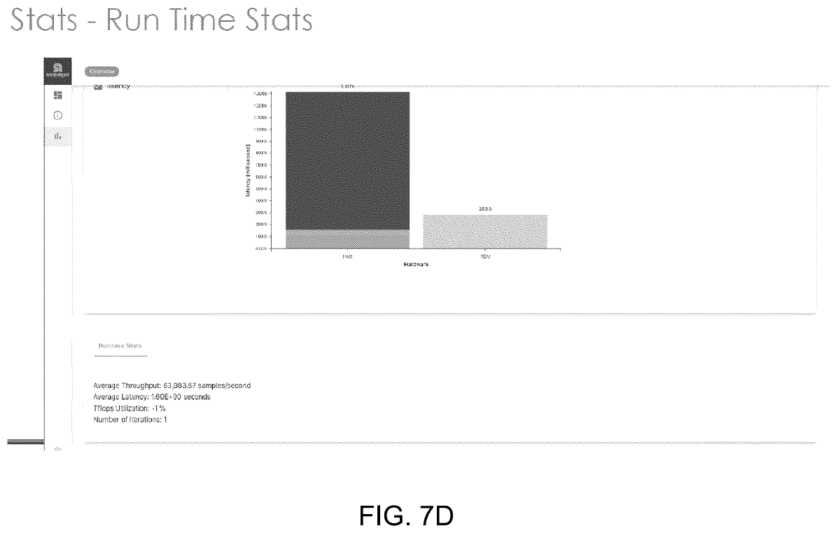

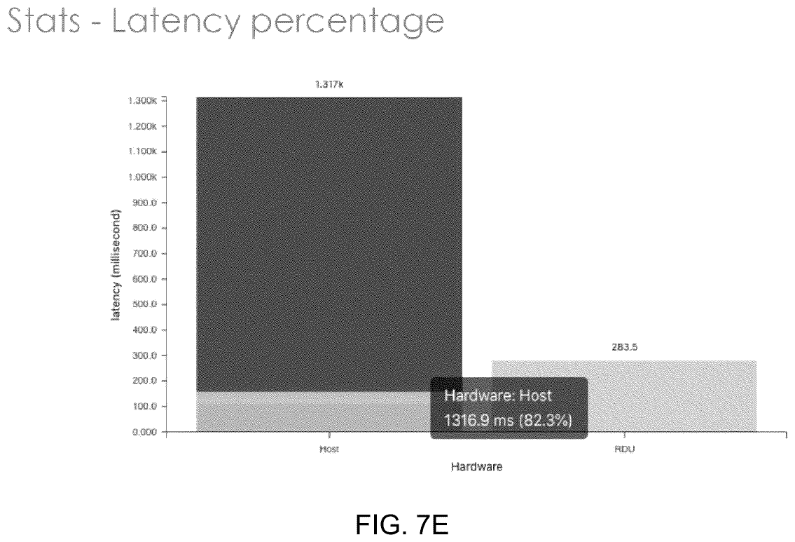

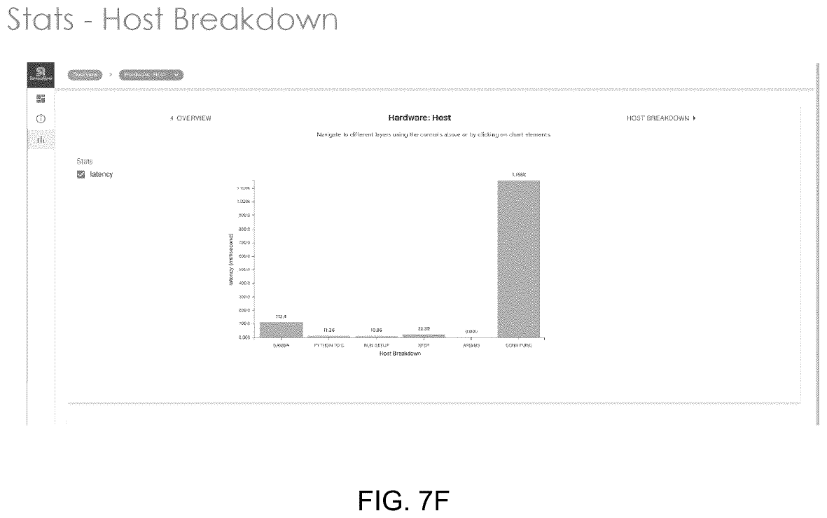

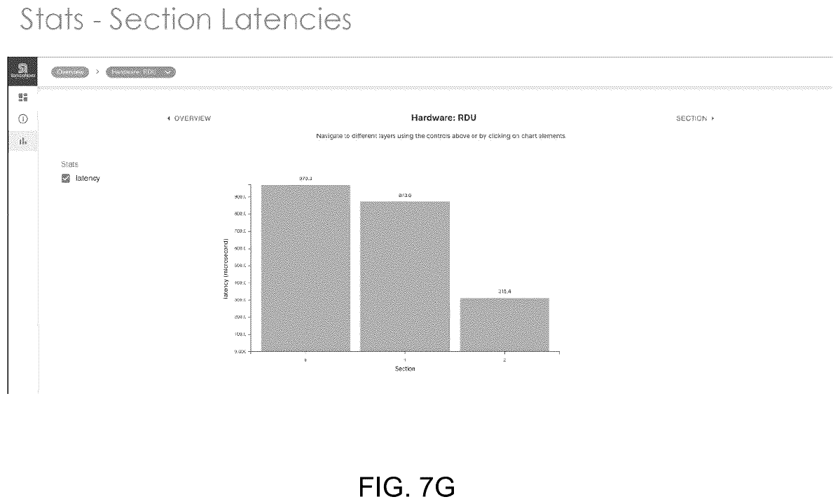

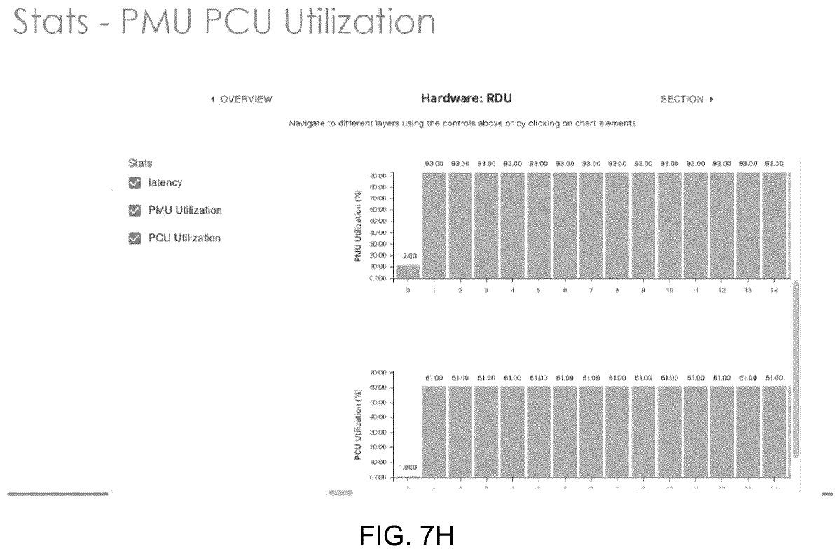

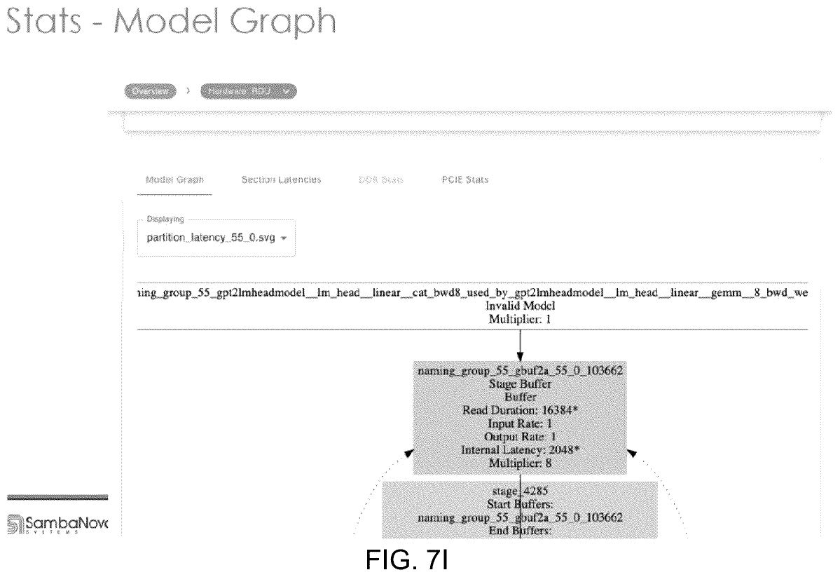

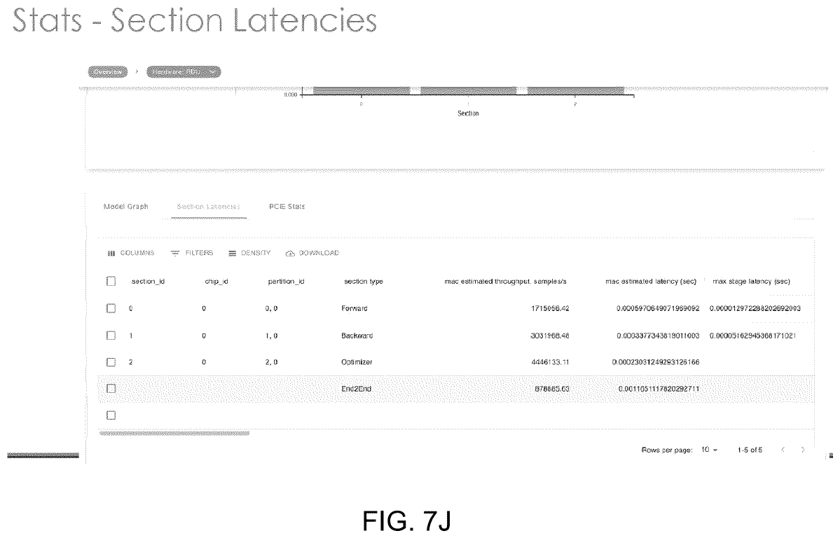

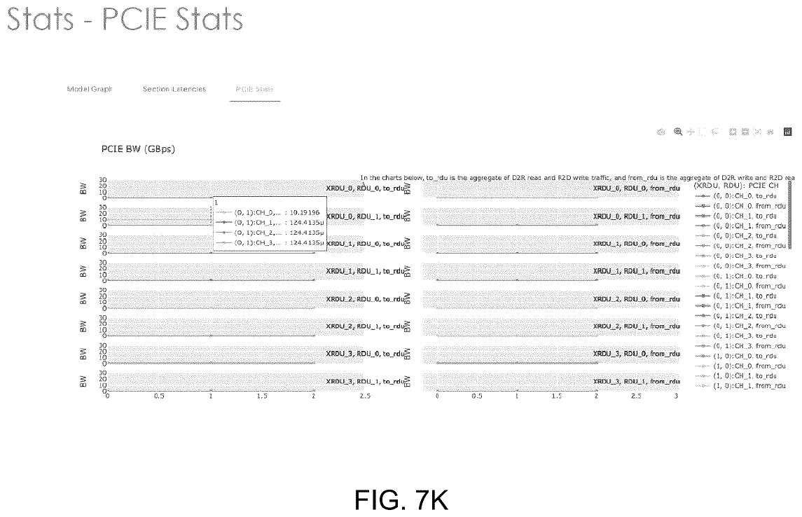

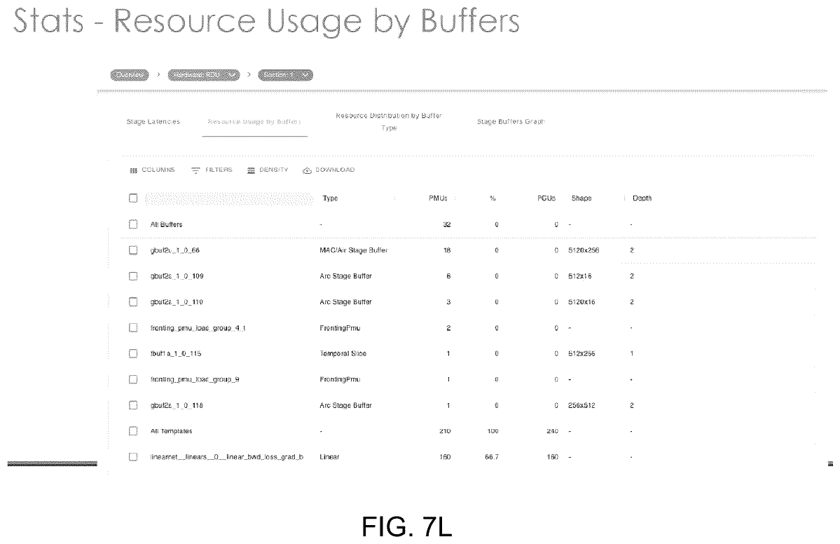

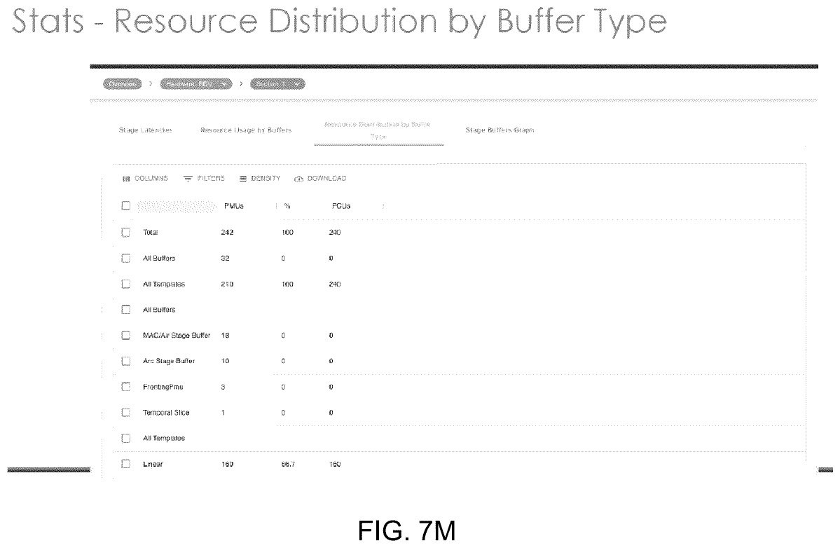

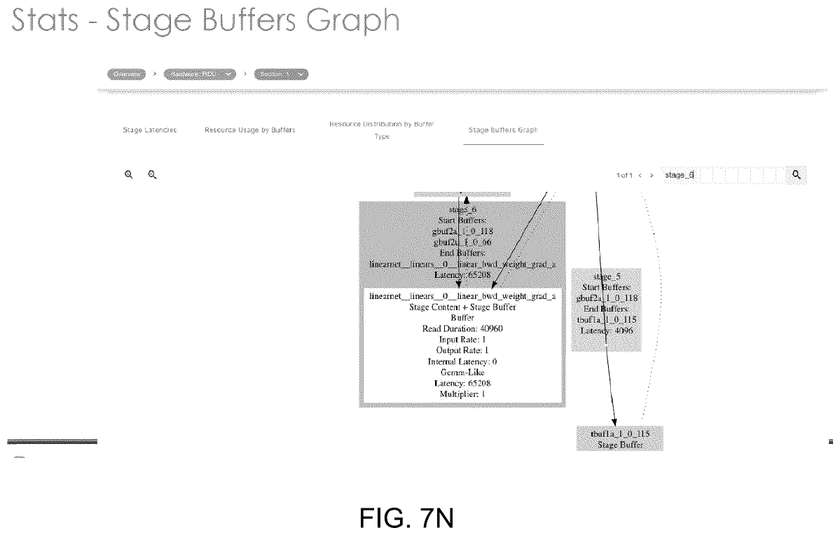

FIGS. 7A-7N show example screenshots of the user interface for SambaTune. This include screenshots of FIGS. 7A-7F showing the breakdown between hosts and the CGRA processor subsystem (reconfigurable data unit—RDU) as well as screenshots showing per-section latency and utilization graphs of FIGS. 7G-7J. FIGS. 7K-7N show runtime resource uses of PCIe and local memory of the RDU.

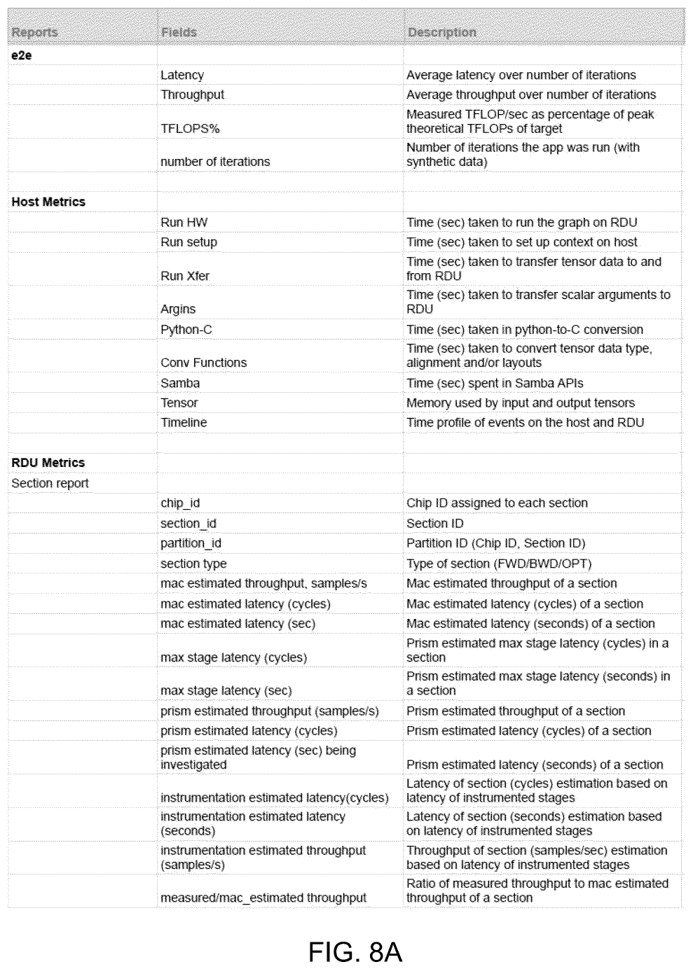

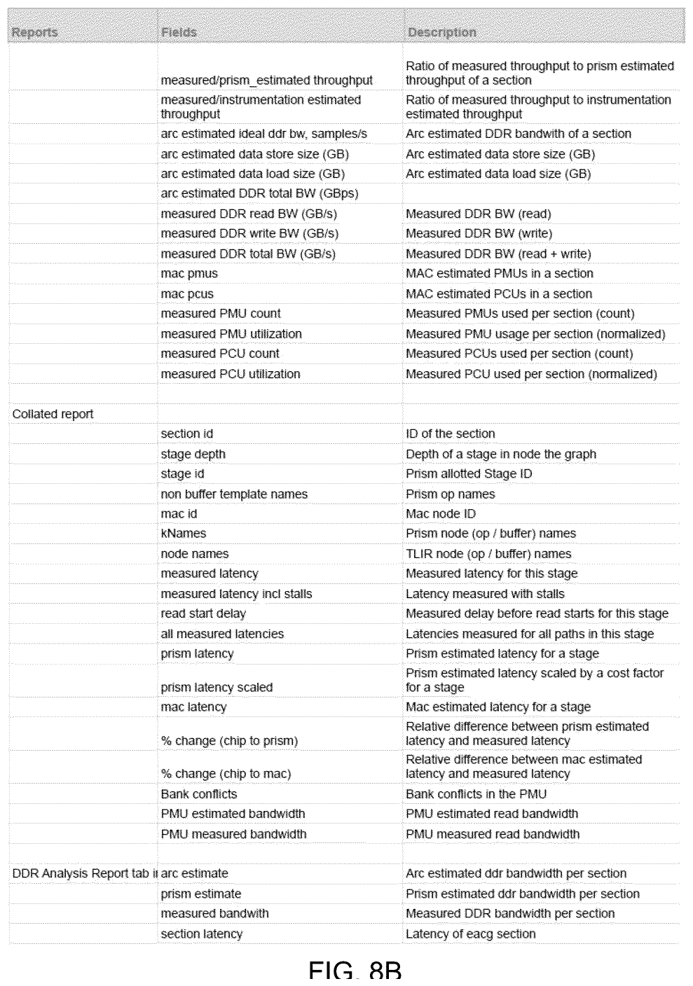

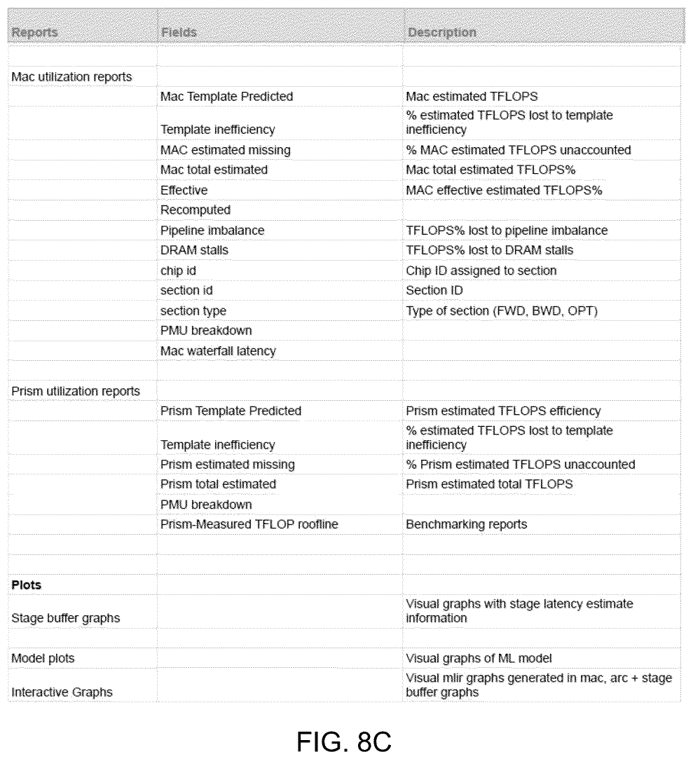

FIGS. 8A-8C is a table showing example fields that may be reported in SambaTune reports.

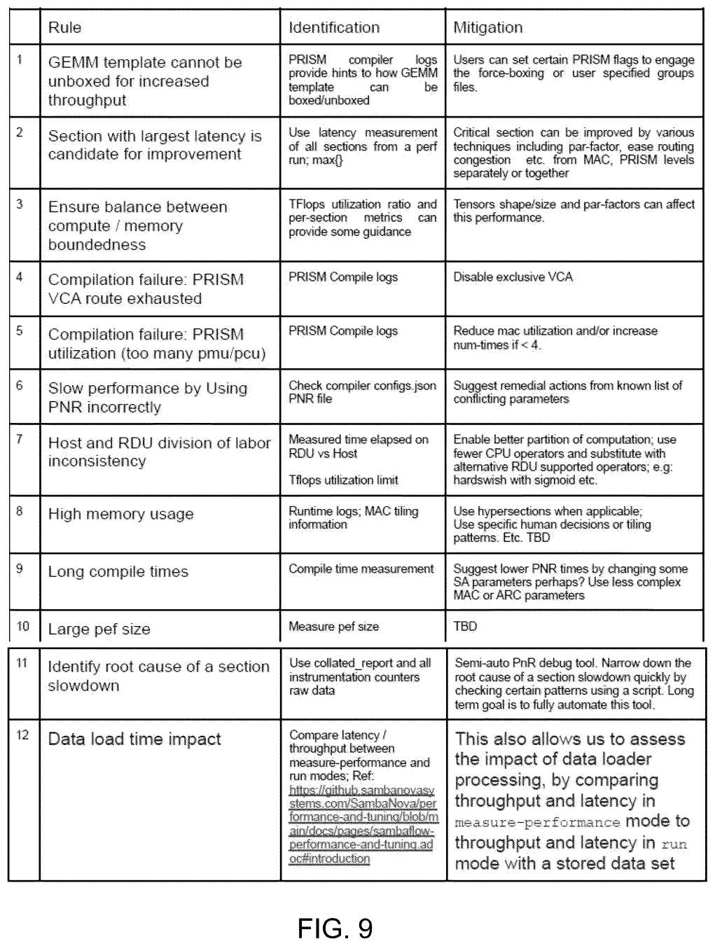

FIG. 9 shows example idioms and design rules for an implementation of SambaTune. They are examples of actional insights from SambaTune. Users can benefit from SambaTune enforcing/highlighting issues, based on a common pool of idioms that work well for various combinations of SN HW+Software, and aid toward various performance debug and analysis phases of model bringup.

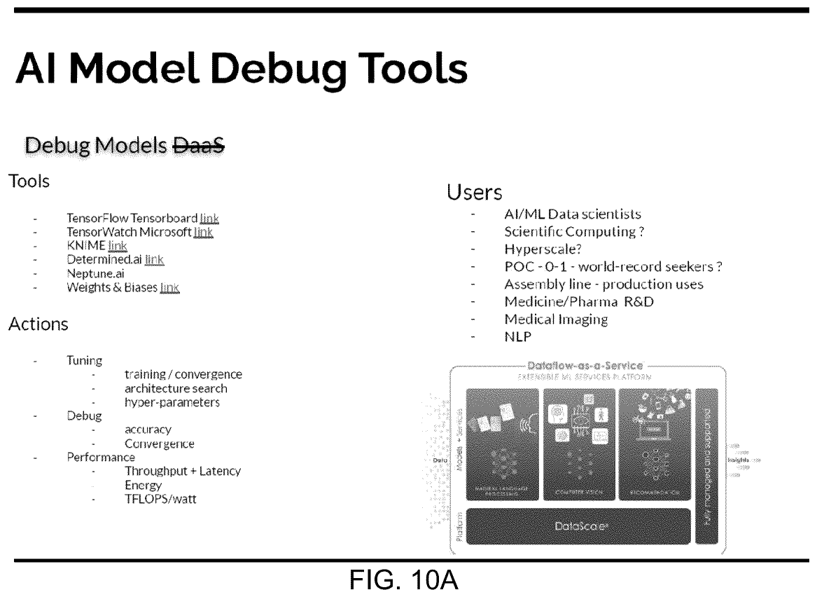

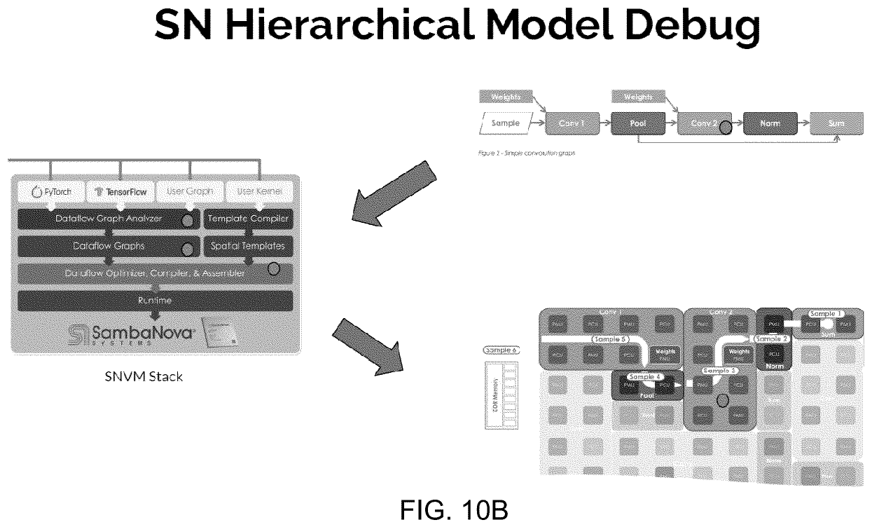

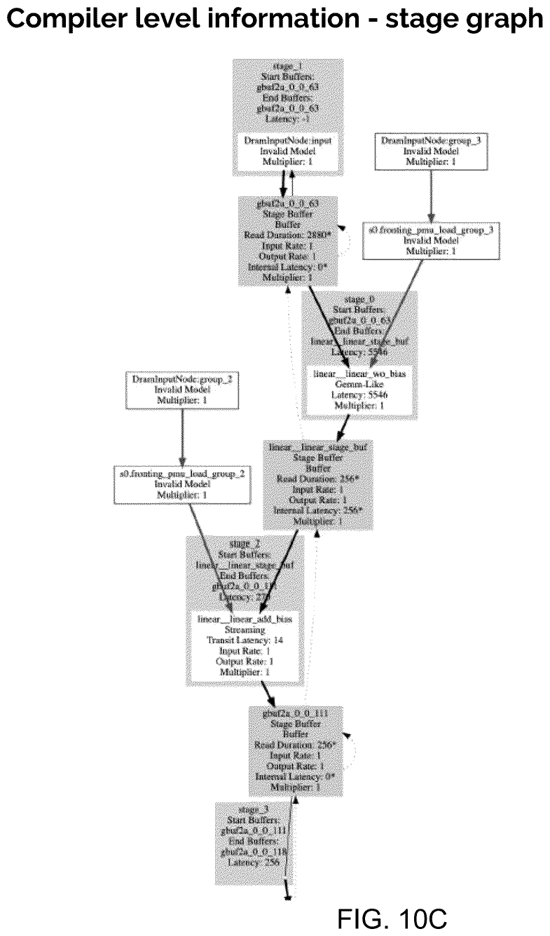

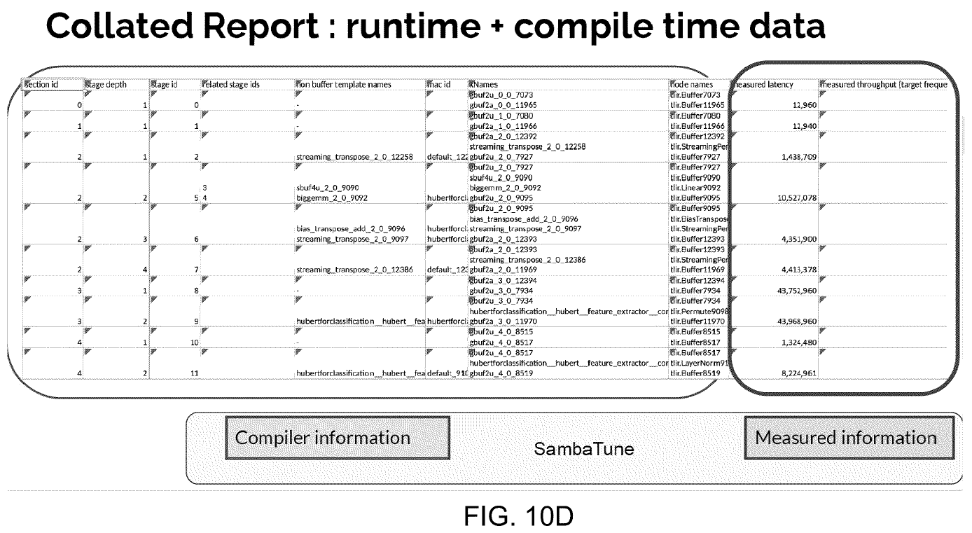

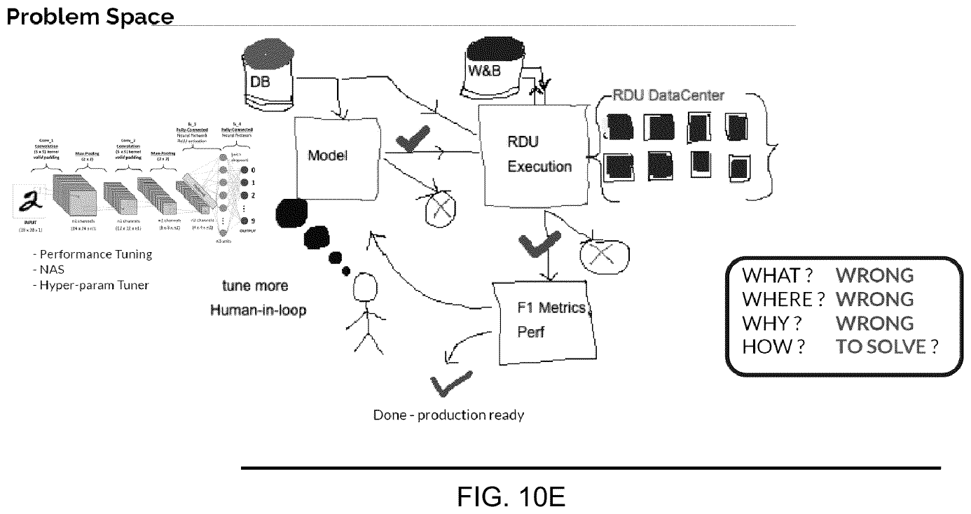

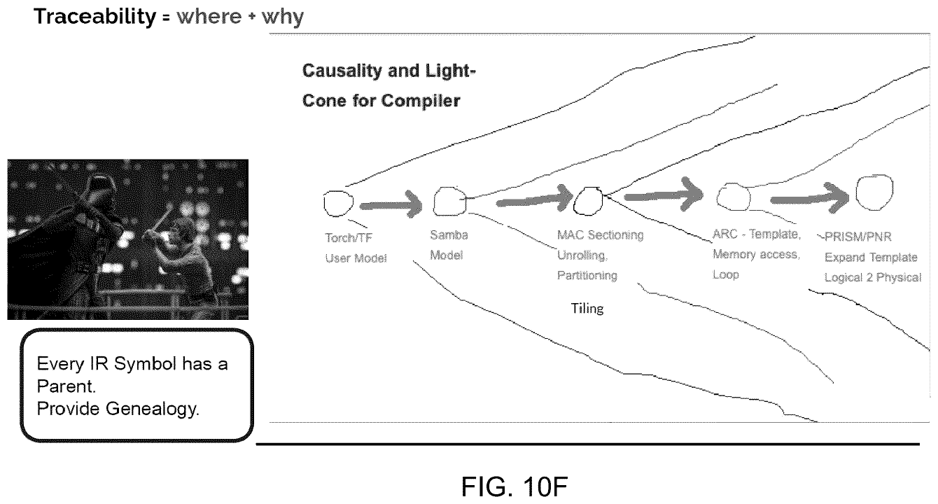

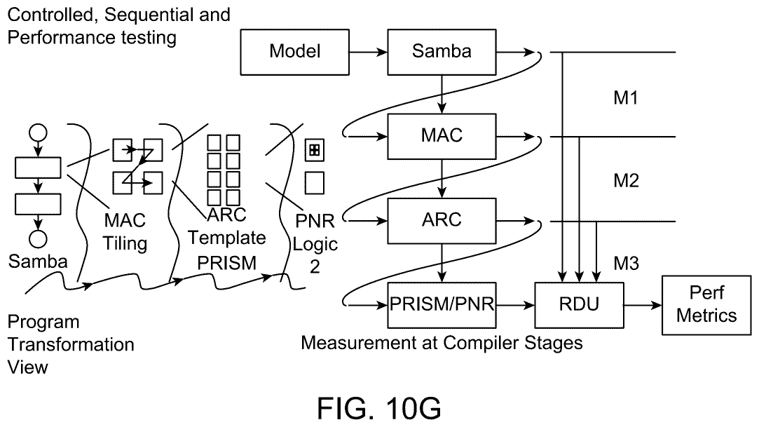

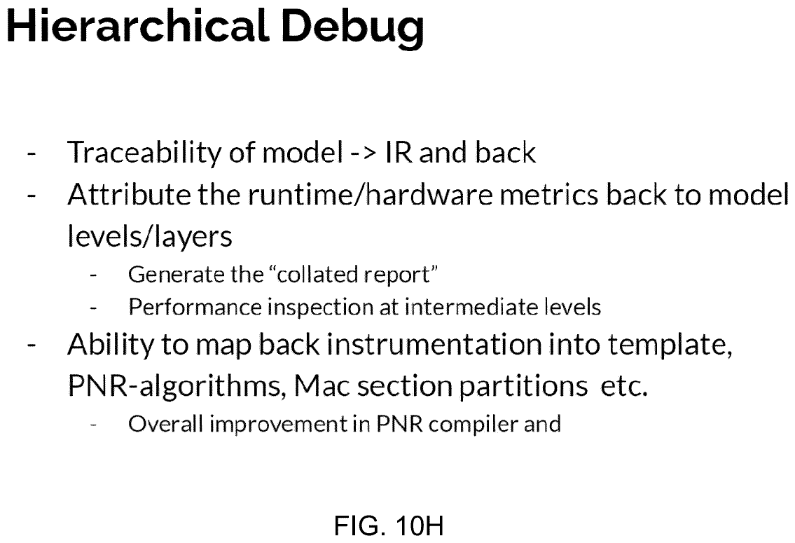

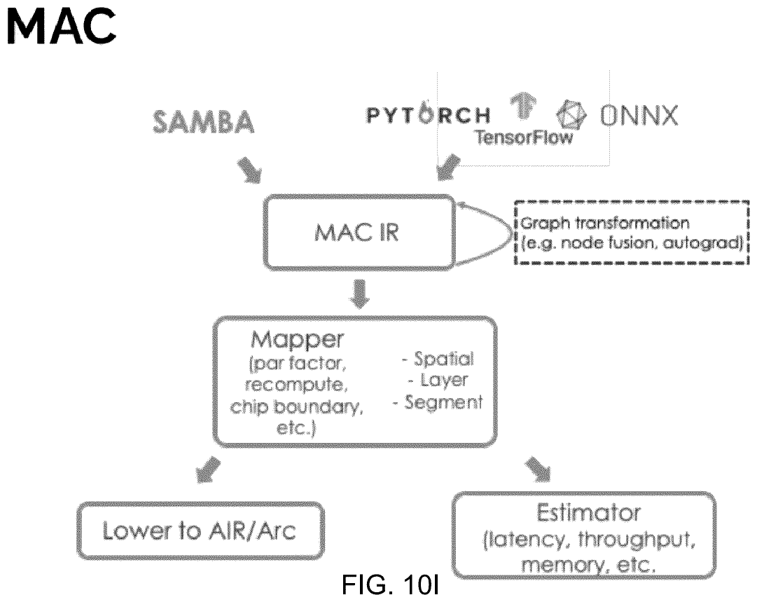

FIGS. 10A-10I show elements of a hierarchical debug using SambaTune.

So, the main idea is, like, you know, hierarchical debug. So, this is, you know, other tools kind of have some of it. So, these are some of the comparisons that we have done, yeah, I model debug tools and you know these are all other companies that have. Similar tools like SambaTune. Determined as a company, Neptune as another one. So, there you can see, you know, ways charts and summaries and So, on. So, they let you monitor training as you know, they call it epochs because you have to take a fraction of the data set, train the neural network and typical training processes. You just flip the neural network. The data set into training and validation like a 7030 and then you use training set to train the neural network and then validate it against data that it hasn't seen which is 30% of the split call. So, the. Validation data set and then you kind of will look whether the accuracy on the training is reflected in the validation and then you can kind of. You know. Infer whether the neural network is actually learned, the model distribution, or just learned the data. And you want the real network to learn the model distribution, the data distribution, not the data itself. So, you know there are. Other tools here and then you know SambaTune is sort of not exactly at the tuning level in terms of. Training, monitoring and So, on. We are specifically focused on getting Max throughput and we talked about this.

This is the hierarchical debug that SambaTune can enable, and we have all the pieces, and you know you can trace this sort of. So, you can trace this red dot on the neural network. That is what you see at the PyTorch or the samba level. And let's say you want to dig into how well this convolution runs on our RU. Then you follow the red dot to our compiler stack. And it goes through the different phases and then eventually comes out and it's mapped to place-and-route (P&R) and it's mapped to a particular set of PMU species that are configured in the tile, and there's no delineation. I mean, the delineation here is just. To there's a guide to the eye to indicate, you know, sort of. The PM your PC U in this grouping corresponds to the convolution layer, but really need not be. There's nothing separating them from operating. In auto pipeline way. So, what we can do and what we are able to do today is we are able to identify you know several of these. This is a data flow machine and it's configured for. Every shape and every configuration of the neural operators seen in the deep neural networks. So, Resnet has a particular. Shape, you know. You know Transformers, they have all different configurations of these neural operators and then they can be mapped into the RDU through our compiler. So, when we go through this process, we can, you know, the compiler can tag the parallel sections, the parallel stages in each section. So, that is what we call stage ID. And you know. These are going to be very important for us to, you know, So,. So, they have this notion of the stage ID, which are basically parallel pieces of. Hardware which are executing simultaneously in the section, and we can tag them and attribute them and figure out how long it takes for the stages to run and stuff like that.

So, SambaTune's special ability is to add instrumentation and tag them and use the tagging in the compiler and observe them in the runtime. For example, like the, this is the end report where we correlate both the Samba Kun. You know some, but So, this is just the compilation picture. So, far, we're only in the compiler and the compiler gives us the stage ID. Like what portions of the convolution operator are running in parallel. And you know all the parallel paths within the convolution operator and others mapped in this particular section. So, each run of the RDU, each tiling configuration of all the 6:40 elements in Rd. is called a section, and you can have multiple chips. So, then. They call partitions, So, that's how our hierarchy. So, we have a notion of. Section is basically a partition. Partitions across. What's the RU? Look at they can be running. You know that is the. The compute graph can be run across multiple areas, and then each RDU is a partition of a section and the whole collection of the partition is the entire section. Usually, the section is just one chip, but sometimes you may need multiple. So, that is, you know in So, those cases are called model. Parallel and then pencil, parallel etcetera. But yeah, for the simplest case it's just, you know the partition and section are the same and within each section we have within each section we have a notion of a stage ID. Which indicates the series of PMUs & PCUs which have to be selected.

We have the notion of stages, basically stages which operate in parallel. So, there are portions of the convolution operator when it comes through the compiler, as it is expressed on the CPRA different sections of the convolution operator can operate in parallel, and we call them different stages. And what the compiler does is it can instrument each of these stages and we can look at it in a little more detail and kind of bring that up. So, it can, you know, represent these stages. So, these are some of the reports generated by SambaTune. So, this is the key. Piece, right, So, we are able to identify all the buffers and things like that in the operator and those are the names here. We have stage ID which represents like you know for example when you look at this document, you see what are all the unique stage IDs. These buffers belong to. So, we have several stage ID IDs here. And then we have measured latency, So, this is the. So, this is RU runtime artifact, right measured is also runtime artifact whereas and also measured throughput in frequency samples per second in. So, these are just scaled numbers because sometimes the RU may be overclocked, So, the measured throughput and the measured frequency are slightly different, but you can see all these are measured numbers from the run time and whereas you have. With some and mark latency. So, we call the PR portion and the template assembler portion is person. I think it's like an acronym for Plasticine Intermediate language, something like that. So, this is the person estimate and you know, we just as you know in this column we say what is the difference between person ship. So, that means whether the compiler. Just doing the correct estimate or not. So, here you see this one wildly off this particular, you know row for this buffer. Or the name of this this operator and then we can kind of, you know, use these names to look up the chain of where it originated from in the neural network. Right. So, that that's how people are debugging using this information today. So, change from chip to mark. So, in this case the mark does not have latency for many internal buffers, So, this is kind of understandable.

As we go through the compilation flow, you can see from our compiler. So, Mark is essentially like the A model analyzer and compiler. So, it's just the data flow graph analyzer right here and it doesn't lower the templates. Further, it has a notion of what is the convolution operator and what is the operator. In terms of the torch and the framework, we call it the torch tensor. Flow and etc. And then it has an estimate of how much compute TFLOPS it needs, how much memory it needs and so on. And then it kind of comes up an estimate. So, it doesn't look deeper into the implementation of the neural network and how it maps into the how the kernel, its. Requesting how the kernel that is supposed to, you know, create it for the template operator. How that is going to map into the PMUs and PCUs at a very detailed level, because that graph is not sort of lowered into the actual template. And you know that is being done by the Ark and the prism and then they have better estimates. So, that's why you see the prism estimates are really good here. So, they have that in the ballpark for most of the cases, less than 5% for most cases. Then there are some outliers. These event names are what is generated. You know these event names are what is generated from the runtime because when we compile the model to be run in this sort of supervisory mode. You know already all these counters are being used in the RDU, even if we don't do this supervisory mode, but we need that mode to actually extract the information from the PCUs and then pass it into the memory channel to the host. You get that we call it as instrumentation and then see how much data is being passed and things like that. So, once we get that supervisory information. And SambaTune is able to put together the stage ID and event name and the buffer name and put it back together with the compiler information and we get this report.

So, this report is used for improving our compiler and also this is sort of where we are forcing the. Compiling information to like sort of meet the truth of the runtime information and then by having this sort of a feedback cycle, we can make them converge towards each other. Right. So, that's the aspect that I want to, you know, propose for the patent application today. Yeah. Let me do this. And you know in determining the stage ID from the compiler, it's not a very one to one because you know this is the aspect of the graph that indicates how you know the model sort of becomes more and more fine-grained as you start at the. Framework level like TensorFlow or PyTorch, that is the user model. They say OK, I want like you know I want a fully connected layer. I want a convolution layer. I want a down sampling layer. I want a drop out layer. I want a SoftMax layer. I want really whatever and then you go into samba model then Max kind of estimates it and. Also, math does sectioning and rolling partitioning and tiling. And within each style of the arc tries to you know lower that particular operator into the corresponding handwritten kernel. We have a library of kernels and then it swaps them and then the graph becomes even bigger and then prism PNR looks at each section and then just tries to say OK. You know, you're just a graph without a position on the tile. Then we will find out how to put the operators on the tile and then connect them up via the control and data flows and then you know orchestrate the. Execution. So, when you go from left to right, basically there's order of magnitude increase in every step of the graph, So, it is probably like 1000 times larger when it started out here. So, I would say So, therefore every IR symbol has a genealogy here, So, it's like.

If I take So, I've got my user graph and I run it through, you know, all these, I run it through the whole set of compile stages and I end up with a, you know, a place and routed graph. That's mapped into the RDU's. And you know create this load file that I can then load and execute in the in the already use and it sounded like you said that all the counters and everything that. Can count. I don't know how many cycles latency at this very granular level. Yeah, and I guess. Build up a whole hierarchy too. But those are built in automatically anyway, independent of this, this tool or independent of some tune or. Yeah, yeah, because the data flow. It's sort of always. There to take advantage of but it's, but things don't necessarily have to take advantage of it. Yeah, yeah. Because you know the data flow machine, the RU, the CGR is essentially a data flow machine, and it doesn't have that pointer and instruction pointer like a standard, you know, a von Neumann or Harvard von Neumann architecture. It's not like for a risk machine. It doesn't have a notion of what is the next instruction to be executed. It just uses counters and it's sort of like credits. So, when the particular compute layer is finished processing whatever it has. As when all the data becomes available at the input of the PMP CU then it says OK. I finished processing and then it will ask downstream of that. If you're ready to accept, you know, samples from my processing, then it will just pull it out. So, it's almost sort of like, you know, the output it's pulling the input. Through this compute. And then you just like one at a time. You just like bubble through.

So, this system just uses counters. It's just like, you know how? It's almost like a Internet network kind of thing, like where you're saying. OK, I got this. Now you can send me the. Next one and. That, you know, they're doing that underneath at the very tiny granular level and by that way you can imagine like, you know, if some let's. OK, let's just. You know, you can imagine how this may work. So, you can imagine how this would work out, for example here. So, let's say sample three or all this portion and sample three is, you know, sample 3 doesn't take a long time to compute, but sample two. So, when data comes in right, So, the first sample will be processed here, it'll move here. Then this one becomes empty and. And it pulls in the data from the RAM and So, on, and then the sample on bubbles, bubbles, bubbles and as it bubbles the one that's waiting outside comes in and its sort of a queue really here. And the way that's being orchestrated is by the use of counters. It says So, sample three this section here. Should say OK, I have a lot of space, I have nothing to process So, I'm ready to receive whenever you're ready, So, I'll send the stream. The control network basically, So, that will send the you know this section of to this PM PC U it would say OK I have So, much free space and then the PC will say OK, I just have one sample here you go and then it'll just go send it and then it would update the PCU. Right.

So, there's a synchronous control network that's kind of operating at every clock cycle. It's part of our hardware framework. However, this hardware framework can be accessed. They call it a control status. And it can be accessed by the PC's and the PM use as well, and you could read it and store it in a nearby PMPC. And this is the non instrumented view of this graph where it's just set up to run as fast as it can without being observed. And when you want to observe those control. Status registers on certain paths. Then we go through the compilation phase called instrumentation, and then we read those control status registers and then put them in the PMU, which has like a little bit of scratchpad memory. And then you're kind of tracking all the. How many times is fired and stuff like that and how many data, how many pieces of data were moved and at what times and you know, start and start times and all that and you see them in the scratchpad. And when this section is done executing, this scratchpad will be moved into the back into the host, and the runtime keeps track of that. And it dumps a file and then what SambaTune does is we go look at that particular, you know down. And then we associate that with the corresponding compiler dump of the compiler graph. And what are the stage IDs and what are the stage names? And then we can associate them and we come up with this chart, which is really like useful, because now we're talking about. Not how long the PMPC work, but how long a portion of the compute graph took to execute, and then we can associate this with critical paths and we can associate it with. Maybe the template needs to be improved or the PNRS you know.

For example, let's say if sample two is, you know this section in the norm doesn't have space left. Let's say for whatever reason and sample three is completed processing. But it can dump the result and therefore it's stalling. The whole queue. Yeah. So, those kind of situations can be observed and. Instead of observing at the fine-grained template level, you can observe it from applications and then if you say OK in this neural network which is for GPT or for language models or vision. And the recommendation systems the Gen. template is great everywhere else, but for this model it is not good. Then we can go have some tweaks to it and then have the compiler pick a different kind of a template. And then use it. So, these kind of things are possible. Because you have the ground truth from the counters on the system. And you have modified the graph slightly to observe the context, and then you just put them two together and we have. Of basically the measure of what is happening in the system at application level, I think that is sort of very useful and our compiler stack has been with the man in the loop or the person in the loop kind of way. And these tools have helped improve our. Like, are you able to do something at a more granular level or a more, you know, in a sense of I have counters that count almost down to this PM UPU level and functionality, whatever the function got mapped on to that. Like the you know the actual user graph that was input and how it got mapped at every stage.

So, you have a picture data set of cats and dogs, and then they want to see whether the model can be trained to identify cats or dogs. And then you want to see what is accuracy. And then in this case, that's how they're saying. So, the loss and one of the things you do typically in training neural networks is as the number of epochs grow and you're doing this back propagation to train the neural net. Or you want to see the loss go down and then for example, in this case you can see the loss is going down and it's plateauing and then you can kind of stop training at that point. So, it is a model level debug tool whereas SambaTune is a more performance and the bottleneck debugging tool So, exactly. What we just discussed earlier. We are able to identify at this level the stage and things like that from the compiler and observe them from the hardware. Right. And then because we observe this data and then we have the chain of genealogy tracing all the way back to the user model, we can essentially say how long this particular operator took to run on your RDU.

After this compilation of these options and things like that, and it's a causality and like cone for the compiler, it's almost using some of the physics concepts because each PMPC they didn't just simply, you know, pop out of the vacuum, right. So, they come. Because the user chose to use certain operators because the compiler chose to expand that operator in terms of certain templates and kernels and things like that. So, we are using that concept to chain back. That's OK, good. It can be used for. You know graph core NVIDIA or Intel. Or they could just run on any hardware, So, they're not specific. And then they also would not be able to give the fine-grained granularity of, you know, they're not essentially like a compiler. Bug too. So, in our case we could say SambaTune essentially improves the P&R quality by you know marrying these two pieces of information and so on. So, I think 2 main things, or maybe three main things today. So, we could just probably summarize. At this level, yeah. So, somebody enables hierarchical debug, So, that is the first main thing, traceability of the model to IR and back. And you know, attribute the on time. And the hardware. Metrics back to the model levels in layers. So, that's one thing and then you know that directly enables performance inspection at intermediate levels. Then you know these are all like probably other. But it sounds like, OK, So, if I'm understanding properly the way that people are doing this now, they don't really have this instrumentation that and I'm going to call it or hardware capability because I don't want to overload instrumentation the way it's described.

Here's how the counters work, or where they're at, that they're mapped, but. Basically, you're saying I have to do instrumentation right before I run it. If I'm going to be able to do this analysis to marry the two the how I got there, OK. But we want to discuss somewhat is how the instrumentation is created in order to allow the level of granularity that you want to see in the analysis afterwards. Seems to be what we're saying doesn't happen in other systems that there's this mapping that happens that you're doing this instrumentation and then on the and then you let it run and but because you did this instrumentation, it stored. Bring the particular counters and such that are mapped back to the graph and then and then. I guess there's this post processing stage that you have and that once I've collected all that data that I can post process it. And marry it back at the graph level. And what I need to have for the application, I think we need to describe how exactly that's done. So, for example, these are examples of the you know what we call the data flow graphs within the compiler. And you know, at this level it's still very coarse. So, this is. Maybe at the Mac level So, you can see it just has weight and input and then it's a training backward layer for the multiplier. So, you have the previous gradient and then you have. You know you're computing the weight grad and then this. Linear input grad and then you'll multiply the two later. That's one level, and then the forward. Is the corresponding one the forward computation. You can see it. So, these are still at the Mac level. They don't have any fine-grained information on this graph. Let's just see if there's more. OK.

So, this is the notion of the stages. So, if you just see it. So, in this case it's a very simple model. So, usually we have hundreds of these and the models can be very big. So, in this case, they're just doing a matrix multiplication a*B, So, you know they call it stage one. That's a stage one stage zero and a stage two, and we were debugging this for some case. You know, it's probably not relevant for our discussion, but the main thing I want to show you is. A simple node with two inputs and matrix multiply and output. When you look at almost the last layer. At P and. R This is how it's going to look like. It's going to have a notion of a DRAM input node to load the weights, and it's going to have another node to load the input. And then it's going to buffer them, and then you know it. It's going to go into the multiplier. And So, you see that it has a like, a multiplier state. So, I think this whole section here forms a multiplier and then it's going to write that result back into the RAM back again. So, you see DRAM output. So, in this case we need to know who's stopping it. So, several things could be going wrong. Why the? So, let's say we do the instrumentation and then the reports will summer tune and it tells you the multiplier is not working fast. Even though data is available, then you go look at it, why is the multiplier not working fast? Are both pieces of data available simultaneously, So, you can just query whether the collated report shows whether this branch for loading the weights is running on time. You can look at the latency of this and latency of this. So, when both of them are available only then it can start multiplying. So, that could be a source of problem or you could go. Look here, whether the multiplier is able to finish its job, but it can push the results out So, it's working on a quantum of multiplication and stores it in the intermediary, but it can move that out to the output. Then it can consequently it can pull the next quantum of work in. So, then you can look at the latency from here. So, you can do all these kind of analysis. Right and. That is really what we are claiming in this application and we say that it can lead to.

So, you can change this information up all the way through the different compiler layers all the way to the framework layer and tell the user that you know the way things compile and the way. Your architecture was chosen and the number. Of chips, you. Chose and how you're putting up your data. Things are moving fast and this is exactly where it's not moving fast and we can pinpoint them to that. That's one thing, and the other main take away is we have been able to improve templates and other designs. Kernel designs for our hardware by programming at the very lowest level using this technology because we're able to see what is stopping the particular, you know what is stalling the pipeline from moving the data through. So, that is one of the, you know, key limits to why performance is not effective in data flow machines, because there are certain stages which may be stalled. And then we have to go and unblock them. So, this then it tells you where is the bottleneck by.

So, this is just the. Compilation level and you know we use the stage ID and the buffer names in correspondence with what the runtime will actually find out, and then put it back together. And also the third thing is if things get stalled, which is like a hang for the program on the RU, then we also need to know why things are stalling. Is there like a deadlock or is there like a resource contention and you know we can identify them? So, we're part of that process. Yeah, So, this is what we see. You know we have a. Collator that what I showed you earlier. OK, let's see. I tried to bring up a colleague at the book earlier. OK, there is the collector, the book. Are you able to see this report like SE? So, the excel sheet has this, you know, So, it has the stage IDs. All those compiler information, these V Buff 2A. These are also all compiler information and within the compiler we know the buffer names and this TLIR is another representation and we can go for. So, there. You could say which operator this belongs to. Go all the way up to that. So, linear mean would mean that it is a matrix vector multiplication with weights and inputs. Then you can see bias transpose streaming permute. So, you kind of get a sense of what these operators are. Whereas we are only covering one level above the SMP and R into the tile, the presentation from Mark if you go one level above, you can actually see the global nature of the operator. So, that is a little bit of hierarchy here.

So, going from column, you know the stage ID to Mac, ID to names and the known names is the hierarchical portion of it. And then these are all the mesh at runtime portion of it and some, but essentially put these two together. So, that's the idea, dovetail both pieces of information and presents the knowledge in context. I think that is kind of unique from my you know, understanding from the system that I have seen it maybe that there are some prior or just I'm not aware of it but. That is compiler output, but it hasn't been instrumentation instrumented. Yes, that graph is. It has been instrumented, that is probably why some of these buffers are there, because they will store the counter value in that scratchpad memory. Because otherwise it would just stop here. So, you just have the multiply. You have the two inputs, then you write it, and then you're done. But all these other inputs and the dotted lines are the control edges and then the solid lines are the data edges, OK, data flow and then the control flow is just saying OK, you can start sending me data. So, maybe it would be useful that there is an another flow chart that looks like this sort of, but it doesn't have the instrumentation. So, we have like. That flow chart then we run an instrumentation and we create this that has the you know that. Because I guess maybe does the stage IDs and stuff too which maybe aren't? There in the. Original or the pre instrumented graph is that and then once. You've done instrumented.

Yeah, stage IDs are always there, regardless of instrumented or not. They are just a notion of the, you know, the sections that are able to run in parallel. Because you can imagine. If this multiplier is doing, you know it's doing batch wise work So, we are a parallel machine. We don't multiply just like 2. Numbers we're multiplying like a bunch of rows and a bunch of columns, and in a batch, and then we move along to the next quantum, and so on. So, as you're multiplying the first batch, then you have to add them and then they may be in the second stage. So, that stage is marked as a parallel operation and then loading is a parallel stage and so on. So, each thing. They will be working on different pieces of data, but they will be simultaneously working and then that is the notion we capture in the data flow graph. That is a separate data flow graph. I can make a note of it and share with. But whether it's instrumented or not, it's just going to make a difference of the number of buffers you see, but otherwise they will still have the same data flow and control flow edges, because without control flow and data flow, you cannot move without control flow. You cannot move the data through the system and everything is like orchestrated. You know a compiler. It's a little bit convoluted, but I hope it makes it starting to make sense, and

So, instrumentation would be a hardware artifact, yeah. So, the software artifact we're claiming is the mapping the you know, instrumentation is done by compiler and it's executed by the hardware and runtime. And then we are saying SambaTune just brings. The you know sort of brings them two together. And then that provides some new insight. So, there's compile, there's instrumentation, there's execution. And there's an extraction of the data, and then there's the. Those that information and map it into this report, I guess, which is, you know, OK, this is the counters that apply to these different operations or stage IDs. You give a model then SambaTune will go, instrument it and run it through all the different layers and then measure the metrics and then some. But you will be able to extract different portions of the. Model at each representation. Debug them, because that is also a typical flow. So, yeah, the large model like you know this GPT 178 billion and So, on. They run in like something like 70 or 80 different sections and each sections run on 8 chips, So, it's a lot of sections. And usually what they do is, you know, because it's a data flow machine, the longest running section is the one that you want to shrink the time off. So, then they just use some but tune and then look at that data and then they just zero in on that one particular section and then they extract that section and then again come back to somewhat. And at this starting point and instead of the full model, they just run that single section and then investigate that. And at that point, they look at all the stages and then they see which stage is running along and why is that? And then they kind of tie down like, you know, like a very Socratic method of like, why, why, why? And we have all this data and. It's been useful,

We have a tool that can resolve differences between compiler and execution and then. We could put these two together. And pass up that detail all the way up to the user So, that you could get the Max T flops that you paid for right and right. However, the place and route part basically takes those connections and places it into the machine, kind of like he showed in those areas of boxes. And then does a route where it's trying to route the data between each box, because they're all in an interconnected graph, a data flow graph, which is, you know how I mean, the RDU is a data flow machine. But then you can get the results of that. And take that back as an input in the compiler stage where it reads. It uses different estimates of how many you know how many PCU's and PM's it needs. You know other definitely different resources and stuff, So, it can take that data make different, provide different inputs into the compiler. To provide more or less or whatever, and it'll come recompute and come up with a different result. That's hopefully maps much better. And that improves performance.

The architecture, configurability, and dataflow capabilities of an array of CGR units enable increased compute power that supports both parallel and pipelined computation. A CGR processor, which includes one or more CGR arrays (arrays of CGR units), can be programmed to simultaneously execute multiple independent and interdependent dataflow graphs. To enable simultaneous execution, the dataflow graphs may need to be distilled from a high-level program and translated to a configuration file for the CGR processor. A high-level program is source code written in programming languages like Spatial, Python, C++, and C, and may use computation libraries for scientific computing, ML, AI, and the like. The high-level program and referenced libraries can implement computing structures and algorithms of machine learning models like AlexNet, VGG Net, GoogleNet, ResNet, ResNeXt, RCNN, YOLO, SqueezeNet, SegNet, GAN, BERT, ELMo, USE, Transformer, and Transformer-XL.

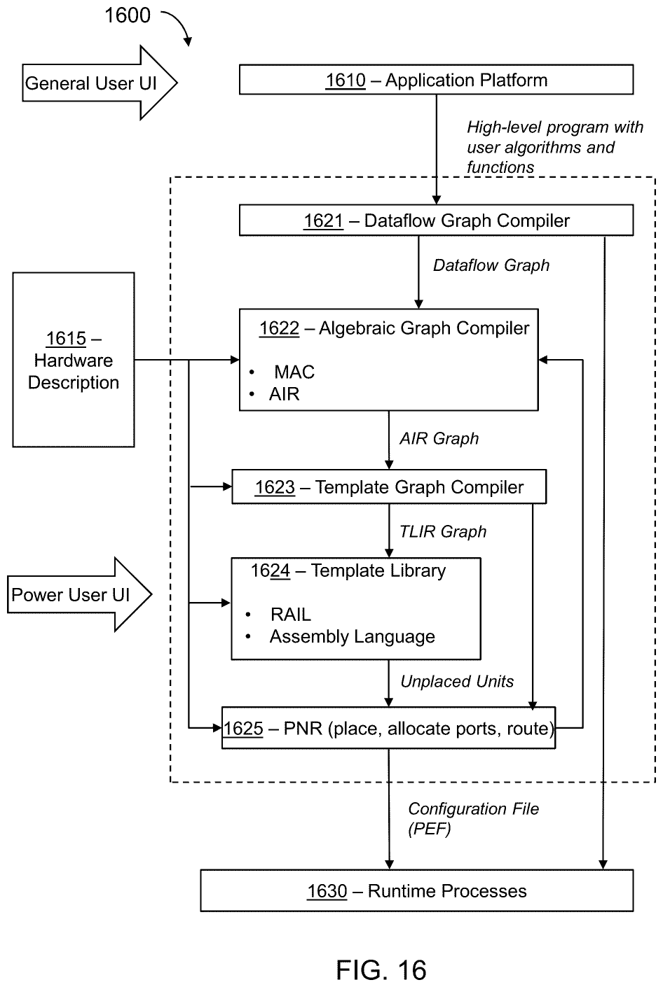

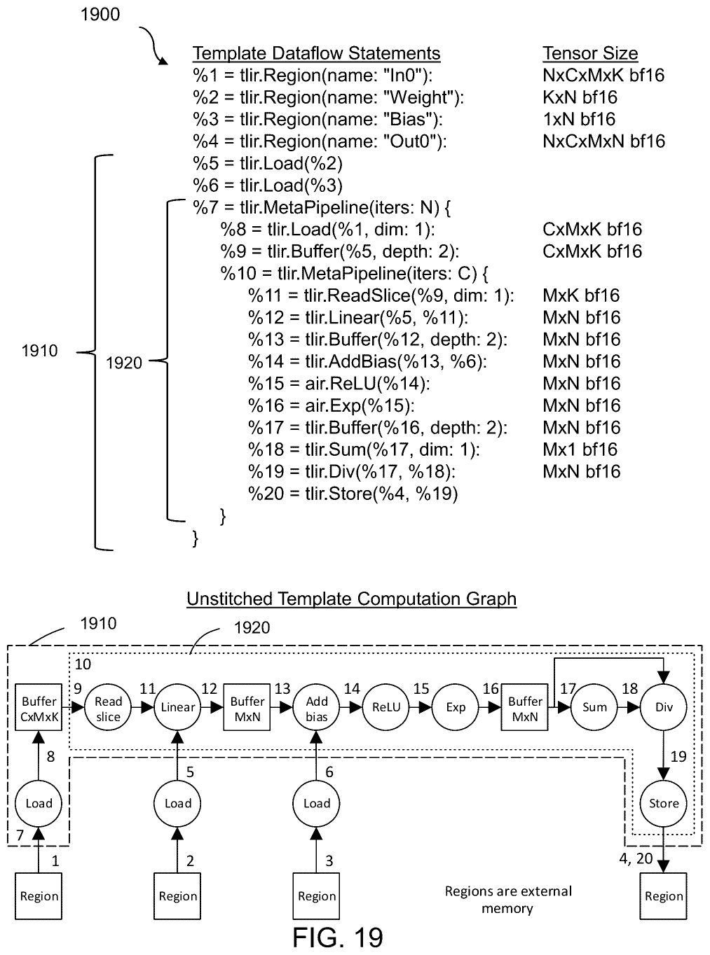

Translation of high-level programs to executable bit files is performed by a compiler, see, for example, FIGS. 16-21. While traditional compilers sequentially map operations to processor instructions, typically without regard to pipeline utilization and duration (a task usually handled by the hardware), an array of CGR units requires mapping operations to processor instructions in both space (for parallelism) and time (for synchronization of interdependent computation graphs or dataflow graphs). This requirement implies that a compiler for a CGRA must decide which operation of a computation graph or dataflow graph is assigned to which of the CGR units, and how both data and, related to the support of dataflow graphs, control information flows among CGR units, and to and from external hosts and storage. This process, known as “place and route”, is one of many new challenges posed to compilers for arrays of CGR units.

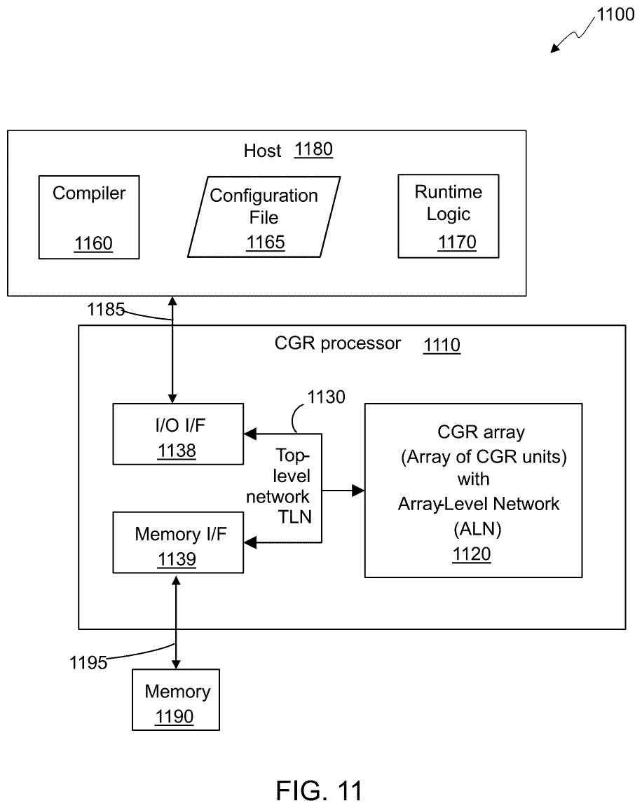

FIG. 11 illustrates an example system 1100 including a CGR processor 1110, a host 1180, and a memory 1190. CGR processor 1110 has a coarse-grained reconfigurable architecture (CGRA) and includes an array of CGR units 1120 such as a CGR array. CGR processor 1110 further includes an IO interface 1138, and a memory interface 1139. Array of CGR units 1120 is coupled with IO interface 1138 and memory interface 1139 via databus 1130 which may be part of a top-level network (TLN). Host 1180 communicates with IO interface 1138 via system databus 1185, and memory interface 1139 communicates with memory 1190 via memory bus 1195. Array of CGR units 1120 may further include compute units and memory units that are connected with an array-level network (ALN) to provide the circuitry for execution of a computation graph or a dataflow graph that may have been derived from a high-level program with user algorithms and functions. The high-level program may include a set of procedures, such as learning or inferencing in an AI or ML system. More specifically, the high-level program may include applications, graphs, application graphs, user applications, computation graphs, control flow graphs, dataflow graphs, models, deep learning applications, deep learning neural networks, programs, program images, jobs, tasks and/or any other procedures and functions that may need serial and/or parallel processing. In some implementations, execution of the graph(s) may involve using multiple units of CGR processor 1110. In some implementations, CGR processor 1110 may include one or more ICs. In other implementations, a single IC may span multiple CGR processors. In further implementations, CGR processor 1110 may include one or more units of array of CGR units 1120.

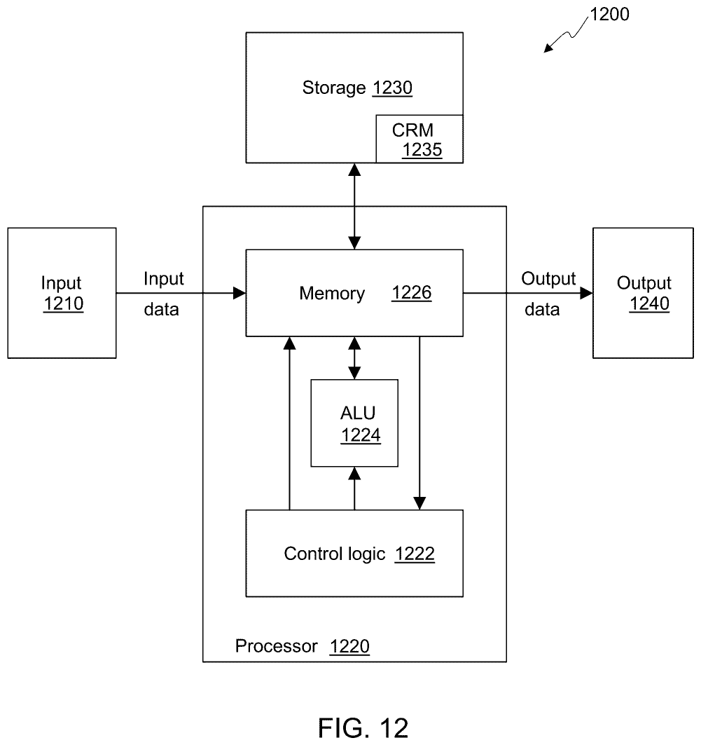

Host 1180 may be, or include, a computer such as further described with reference to FIG. 12. Host 1180 runs runtime processes, as further referenced herein, and may also be used to run computer programs, such as the compiler 1160 further described herein with reference to FIG. 112. In some implementations, the compiler may run on a computer that is similar to the computer described with reference to FIG. 12, but separate from host 1180.

CGR processor 1110 may accomplish computational tasks by executing a configuration file 1165 (for example, a PEF file). For the purposes of this description, a configuration file corresponds to a dataflow graph, or a translation of a dataflow graph, and may further include initialization data. A compiler 1160 compiles the high-level program to provide the configuration file 1165. Runtime processes 1170 may install the configuration file 1165 in CGR processor 1110. In some implementations described herein, a CGR array is configured by programming one or more configuration stores with all or parts of the configuration file 1165. A single configuration store may be at the level of the CGR processor 1110 or the CGR array 1120, or a CGR unit may include an individual configuration store. The configuration file 1165 may include configuration data for the CGR array 1120 and CGR units in the CGR array 1120, and link the computation graph to the CGR array 1120. Execution of the configuration file by CGR processor 1110 causes the CGR array 1120 to implement the user algorithms and functions in the dataflow graph.

CGR processor 1110 can be implemented on a single integrated circuit die or on a multichip module (MCM). An IC can be packaged in a single chip module or a multichip module. An MCM is an electronic package that may comprise multiple IC dies and other devices, assembled into a single module as if it were a single device. The various dies of an MCM may be mounted on a substrate, and the bare dies of the substrate are electrically coupled to the surface or to each other using for some examples, wire bonding, tape bonding or flip-chip bonding.

FIG. 12 illustrates an example of a computer 1200, including an input device 1210, a processor 1220, a storage device 1230, and an output device 1240. Although the example computer 1200 is drawn with a single processor, other implementations may have multiple processors. Input device 1210 may comprise a mouse, a keyboard, a sensor, an input port (for example, a universal serial bus (USB) port), and any other input device known in the art. Output device 1240 may comprise a monitor, printer, and any other output device known in the art. Furthermore, part or all of input device 1210 and output device 1240 may be combined in a network interface, such as a Peripheral Component Interconnect Express (PCIe) interface suitable for communicating with CGR processor 1110. Input device 1210 is coupled with processor 1220 to provide input data, which an implementation may store in memory 1226. Processor 1220 is coupled with output device 1240 to provide output data from memory 1226 to output device 1240. Processor 1220 further includes control logic 1222, operable to control memory 1226 and arithmetic and logic unit (ALU) 1224, and to receive program and configuration data from memory 1226. Control logic 1222 further controls exchange of data between memory 1226 and storage device 1230. Memory 1226 typically comprises memory with fast access, such as static random-access memory (SRAM), whereas storage device 1230 typically comprises memory with slow access, such as dynamic random-access memory (DRAM), flash memory, magnetic disks, optical disks, and any other memory type known in the art. At least a part of the memory in storage device 1230 includes a non-transitory computer-readable medium (CRM 1235), such as used for storing computer programs.

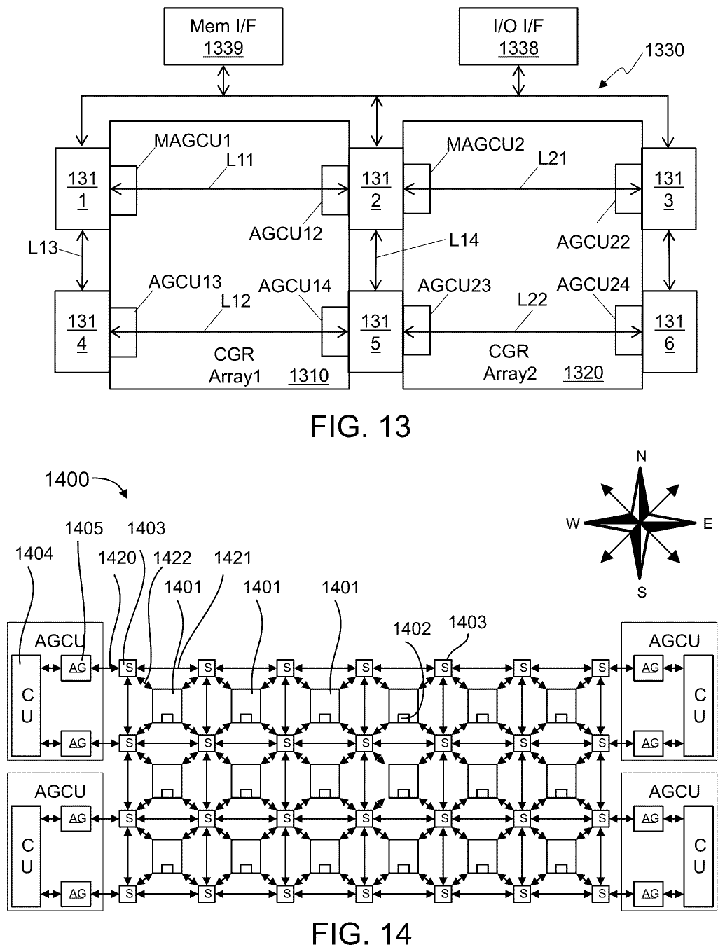

FIG. 13 illustrates example details of a CGR architecture 1300 including a top-level network (TLN 1330) and two CGR arrays (CGR array 1310 and CGR array 1320). A CGR array comprises an array of CGR units (e.g., PMUs, PCUs, FCMUs) coupled via an array-level network (ALN), e.g., a bus system. The ALN is coupled with the TLN 1330 through several AGCUs, and consequently with I/O interface 1338 (or any number of interfaces) and memory interface 1339. Other implementations may use different bus or communication architectures.

Circuits on the TLN in this example include one or more external I/O interfaces, including I/O interface 1338 and memory interface 1339. The interfaces to external devices include circuits for routing data among circuits coupled with the TLN and external devices, such as high-capacity memory, host processors, other CGR processors, FPGA devices, and So, on, that are coupled with the interfaces.

Each depicted CGR array has four AGCUs (e.g., MAGCU1, AGCU12, AGCU13, and AGCU14 in CGR array 1310). The AGCUs interface the TLN to the ALNs and route data from the TLN to the ALN or vice versa. Other implementations may have different numbers of AGCUs.

One of the AGCUs in each CGR array in this example is configured to be a master AGCU (MAGCU), which includes an array configuration load/unload controller for the CGR array. The MAGCU1 includes a configuration load/unload controller for CGR array 1310, and MAGCU2 includes a configuration load/unload controller for CGR array 1320. Some implementations may include more than one array configuration load/unload controller. In other implementations, an array configuration load/unload controller may be implemented by logic distributed among more than one AGCU. In yet other implementations, a configuration load/unload controller can be designed for loading and unloading configuration of more than one CGR array. In further implementations, more than one configuration controller can be designed for configuration of a single CGR array. Also, the configuration load/unload controller can be implemented in other portions of the system, including as a stand-alone circuit on the TLN and the ALN or ALNs.

The TLN is constructed using top-level switches (switch 1311, switch 1312, switch 1313, switch 1314, switch 1315, and switch 1316) coupled with each other as well as with other circuits on the TLN, including the AGCUs, and external I/O interface 1338. The TLN includes links (e.g., L11, L12, L21, L22) coupling the top-level switches. Data may travel in packets between the top-level switches on the links, and from the switches to the circuits on the network coupled with the switches. For example, switch 1311 and switch 1312 are coupled by link L11, switch 1314 and switch 1315 are coupled by link L12, switch 1311 and switch 1314 are coupled by link L13, and switch 1312 and switch 1313 are coupled by link L21. The links can include one or more buses and supporting control lines, including for example a chunk-wide bus (vector bus). For example, the top-level network can include data, request and response channels operable in coordination for transfer of data in any manner known in the art.

FIG. 14 illustrates an example CGR array 1400, including an array of CGR units in an ALN. CGR array 1400 may include several types of CGR unit 1401, such as FCMUs, PMUs, PCUS, memory units, and/or compute units. For examples of the functions of these types of CGR units, see Prabhakar et al., “Plasticine: A Reconfigurable Architecture for Parallel Patterns”, ISCA 2017 Jun. 24-28, 2017, Toronto, ON, Canada. Each of the CGR units may include a configuration store 1402 comprising a set of registers or flip-flops storing configuration data that represents the setup and/or the sequence to run a program, and that can include the number of nested loops, the limits of each loop iterator, the instructions to be executed for each stage, the source of operands, and the network parameters for the input and output interfaces. In some implementations, each CGR unit 1401 comprises an FCMU. In other implementations, the array comprises both PMUs and PCUs, or memory units and compute units, arranged in a checkerboard pattern. In yet other implementations, CGR units may be arranged in different patterns. The ALN includes switch units 1403 (S), and AGCUs (each including two address generators 1405 (AG) and a shared coalescing unit 1404 (CU)). Switch units 1403 are connected among themselves via interconnects 1421 and to a CGR unit 1401 with interconnects 1422. Switch units 1403 may be coupled with address generators 1405 via interconnects 1420. In some implementations, communication channels can be configured as end-to-end connections, and switch units 1403 are CGR units. In other implementations, switches route data via the available links based on address information in packet headers, and communication channels establish as and when needed.

A configuration file may include configuration data representing an initial configuration, or starting state, of each of the CGR units that execute a high-level program with user algorithms and functions. Program load is the process of setting up the configuration stores in the CGR array based on the configuration data to allow the CGR units to execute the high-level program. Program load may also require loading memory units and/or PMUs.

The ALN includes one or more kinds of physical data buses, for example a chunk-level vector bus (e.g., 512 bits of data), a word-level scalar bus (e.g., 32 bits of data), and a control bus. For instance, interconnects 1421 between two switches may include a vector bus interconnect with a bus width of 512 bits, and a scalar bus interconnect with a bus width of 32 bits. A control bus can comprise a configurable interconnect that carries multiple control bits on signal routes designated by configuration bits in the CGR array's configuration file. The control bus can comprise physical lines separate from the data buses in some implementations. In other implementations, the control bus can be implemented using the same physical lines with a separate protocol or in a time-sharing procedure.

Physical data buses may differ in the granularity of data being transferred. In one implementation, a vector bus can carry a chunk that includes 16 channels of 32-bit floating-point data or 32 channels of 16-bit floating-point data (i.e., 512 bits) of data as its payload. A scalar bus can have a 32-bit payload and carry scalar operands or control information. The control bus can carry control handshakes such as tokens and other signals. The vector and scalar buses can be packet-switched, including headers that indicate a destination of each packet and other information such as sequence numbers that can be used to reassemble a file when the packets are received out of order. Each packet header can contain a destination identifier that identifies the geographical coordinates of the destination switch unit (e.g., the row and column in the array), and an interface identifier that identifies the interface on the destination switch (e.g., North, South, East, West, etc.) used to reach the destination unit.

A CGR unit 1401 may have four ports (as drawn) to interface with switch units 1403, or any other number of ports suitable for an ALN. Each port may be suitable for receiving and transmitting data, or a port may be suitable for only receiving or only transmitting data.

A switch unit, as shown in the example of FIG. 14, may have eight interfaces. The North, South, East and West interfaces of a switch unit may be used for links between switch units using interconnects 1421. The Northeast, Southeast, Northwest and Southwest interfaces of a switch unit may each be used to make a link with an FCMU, PCU or PMU instance using one of the interconnects 1422. Two switch units in each CGR array quadrant have links to an AGCU using interconnects 1420. The AGCU coalescing unit arbitrates between the AGs and processes memory requests. Each of the eight interfaces of a switch unit can include a vector interface, a scalar interface, and a control interface to communicate with the vector network, the scalar network, and the control network. In other implementations, a switch unit may have any number of interfaces.

During execution of a graph or subgraph in a CGR array after configuration, data can be sent via one or more switch units and one or more links between the switch units to the CGR units using the vector bus and vector interface(s) of the one or more switch units on the ALN. A CGR array may comprise at least a part of CGR array 1400, and any number of other CGR arrays coupled with CGR array 1400.

A data processing operation implemented by CGR array configuration may comprise multiple graphs or subgraphs specifying data processing operations that are distributed among and executed by corresponding CGR units (e.g., FCMUs, PMUs, PCUs, AGs, and CUs).

FIG. 15 illustrates an example 1500 of a PMU 1510 and a PCU 1520, which may be combined in an FCMU 1530. PMU 1510 may be directly coupled to PCU 1520, or optionally via one or more switches. PMU 1510 includes a scratchpad memory 1515, which may receive external data, memory addresses, and memory control information (write enable, read enable) via one or more buses included in the ALN. PCU 1520 includes two or more processor stages, such as SIMD 1521 through SIMD 1526, and configuration store 1528. The processor stages may include ALUs, or SIMDs, as drawn, or any other reconfigurable stages that can process data.

Each stage in PCU 1520 may also hold one or more registers (not drawn) for short-term storage of parameters. Short-term storage, for example during one to several clock cycles or unit delays, allows for synchronization of data in the PCU pipeline.

FIG. 16 is a block diagram of a compiler stack 1600 implementation suitable for generating a configuration file for a CGR processor. FIGS. 7-11 illustrate various representations of an example user program 1700 corresponding to various stages of a compiler stack such as compiler stack 1600. As depicted, compiler stack 1600 includes several stages to convert a high-level program (e.g., user program 1700) with statements 1710 that define user algorithms and functions, e.g., algebraic expressions and functions, to configuration data for the CGR units. The example user program 1700 depicted in FIG. 7 comprises statements 1710 that invoke various PyTorch functions.

Compiler stack 1600 may take its input from application platform 1610, or any other source of high-level program statements suitable for parallel processing, which provides a user interface for general users. It may further receive hardware description 1615, for example defining the physical units in a reconfigurable data processor or CGRA processor. Application platform 1610 may include libraries such as PyTorch, TensorFlow, ONNX, Caffe, and Keras to provide user-selected and configured algorithms.

Application platform 1610 outputs a high-level program to compiler 1620, which in turn outputs a configuration file to the reconfigurable data processor or CGRA processor where it is executed in runtime processes 1630. Compiler 1620 may include dataflow graph compiler 1621, which may handle a dataflow graph, algebraic graph compiler 1622, template graph compiler 1623, template library 1624, and placer and router PNR 1625. In some implementations, template library 1624 includes RDU abstract intermediate language (RAIL) and/or assembly language interfaces for power users.

Dataflow graph compiler 1621 converts the high-level program with user algorithms and functions from application platform 1610 to one or more dataflow graphs. The high-level program may be suitable for parallel processing, and therefore parts of the nodes of the dataflow graphs may be intrinsically parallel unless an edge in the graph indicates a dependency. Dataflow graph compiler 1621 may provide code optimization steps like false data dependency elimination, dead-code elimination, and constant folding. The dataflow graphs encode the data and control dependencies of the high-level program. Dataflow graph compiler 1621 may support programming a reconfigurable data processor at higher or lower-level programming languages, for example from an application platform 1610 to C++ and assembly language. In some implementations, dataflow graph compiler 1621 allows programmers to provide code that runs directly on the reconfigurable data processor. In other implementations, dataflow graph compiler 1621 provides one or more libraries that include predefined functions like linear algebra operations, element-wise tensor operations, non-linearities, and reductions required for creating, executing, and profiling the dataflow graphs on the reconfigurable processors. Dataflow graph compiler 1621 may provide an application programming interface (API) to enhance functionality available via the application platform 1610.

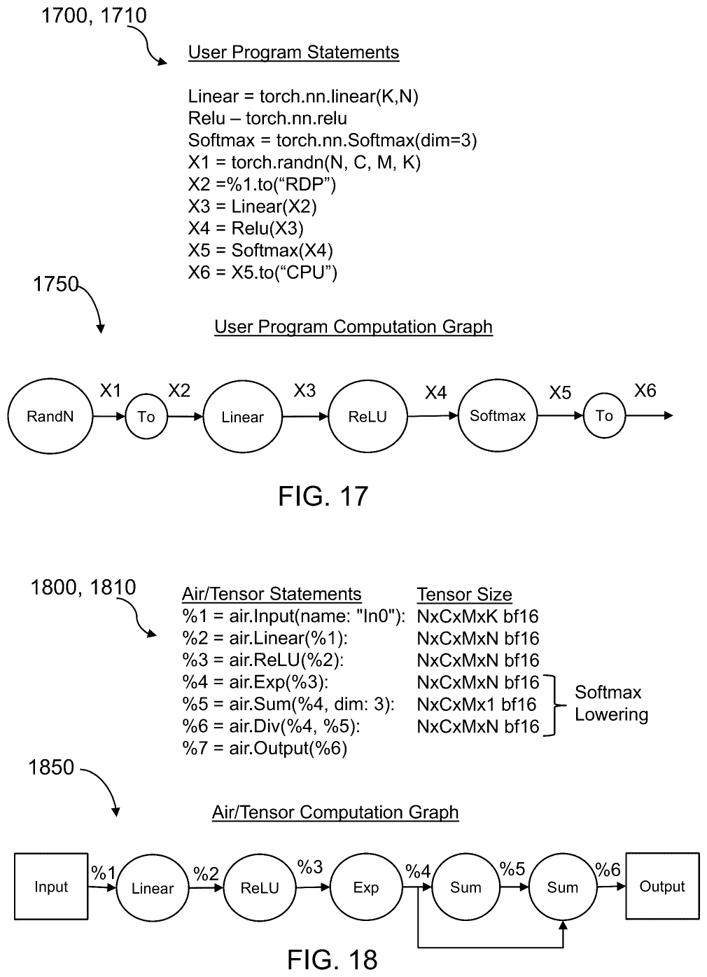

FIG. 17 shows an example user program 1700 in an example first stage of the compiler stack. User program 1700 generates a random tensor X1 with a normal distribution in the RandN node. It provides the tensor to a neural network cell that performs a weighing function (in the Linear node) followed by a rectified linear unit (ReLU) activation function, which is followed by a Softmax activation function, for example to normalize the output to a probability distribution over a predicted output class. FIG. 7 does not show the weights and bias used for the weighing function. User program 1700 corresponds with computation graph 1750.

Algebraic graph compiler 1622 may include a model analyzer and compiler (MAC) level that makes high-level mapping decisions for (sub-graphs of the) dataflow graph based on hardware constraints. It may support various application frontends such as Samba, JAX, and TensorFlow/HLO. Algebraic graph compiler 1622 may also transform the graphs via autodiff and GradNorm, perform stitching between sub-graphs, interface with template generators for performance and latency estimation, convert dataflow graph operations to AIR operation, perform tiling, sharding (database partitioning) and other operations, and model or estimate the parallelism that can be achieved on the dataflow graphs.

Algebraic graph compiler 1622 may further include an arithmetic or algebraic intermediate representation (AIR) level that translates high-level graph and mapping decisions provided by the MAC level into explicit AIR/Tensor statements 1800 (see FIG. 8) and one or more corresponding algebraic graphs 1850. Key responsibilities of the AIR level include legalizing the graph and mapping decisions of the MAC, expanding data parallel, tiling, metapipe, region instructions provided by the MAC, inserting stage buffers and skip buffers, eliminating redundant operations, buffers and sections, and optimizing for resource use, latency, and throughput.

FIG. 18 shows the user program 1700 in an example second stage of the compiler stack. At this stage, the algebraic graph compiler replaces the Softmax macro by its constituents. The Softmax function is given as

$$\frac{{e}^{\{ {z}_{i} \}}}{{\sum }_{j = 1}^{K} {e}^{\{ {z}_{j} \}}} .$$

This function includes an exponential component, a summation, and a division. Thus, algebraic graph compiler 1622 replaces the user program statements 1710, also shown as computation graph 1750, by AIR/Tensor statements 1800, also shown as Air/Tensor computation graph 1850.

Template graph compiler 1623 may translate AIR statements and/or graphs into TLIR statements 1900 (see FIG. 9) and/or graphs (graph 1950 is shown), optimizing for the target hardware architecture into unplaced variable-sized units (referred to as logical CGR units) suitable for PNR 1625. Template graph compiler 1623 may allocate metapipelines, such as metapipeline 1910 and metapipeline 1920, for sections of the template dataflow statements 1900 and corresponding sections of unstitched template computation graph 1950. Template graph compiler 1623 may add further information (name, inputs, input names and dataflow description) for PNR 1625 and make the graph physically realizable through each performed step. Template graph compiler 1623 may for example provide translation of AIR graphs to specific model operation templates such as for general matrix multiplication (GeMM). An implementation may convert part or all intermediate representation operations to templates, stitch templates into the dataflow and control flow, insert necessary buffers and layout transforms, generate test data and optimize for hardware use, latency, and throughput.

Implementations may use templates for common operations. Templates may be implemented using assembly language, RAIL, or similar. RAIL is comparable to assembly language in that memory units and compute units are separately programmed, but it can provide a higher level of abstraction and compiler intelligence via a concise performance-oriented domain-specific language for CGR array templates. RAIL enables template writers and external power users to control interactions between logical compute units and memory units with high-level expressions without the need to manually program capacity splitting, register allocation, etc. The logical compute units and memory units also enable stage/register allocation, context splitting, transpose slotting, resource virtualization and mapping to multiple physical compute units and memory units (e.g., PCUs and PMUs).

Template library 1624 may include an assembler that provides an architecture-independent low-level programming interface as well as optimization and code generation for the target hardware. Responsibilities of the assembler may include address expression compilation, intra-unit resource allocation and management, making a template graph physically realizable with target-specific rules, low-level architecture-specific transformations and optimizations, and architecture-specific code generation.

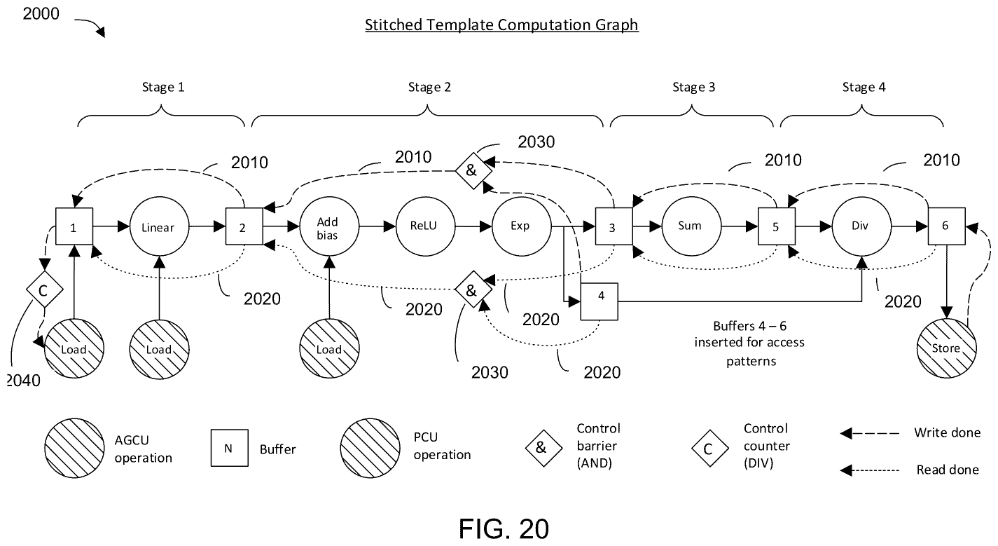

FIG. 20 shows the user program 1700 in an example fourth stage of the compiler stack. The template graph compiler 1623 may also determine the control signals 2010 and 2020, as well as control gates 2030 and 2040 required to enable the CGR units (whether logical or physical) to coordinate dataflow between the CGR units in the CGR array of a CGR processor. This process, sometimes referred to as stitching, produces a stitched template compute graph 2000 with control signals 2010-2020 and control gates 2030-2040. In the example depicted in FIG. 10, the control signals include write done signals 2010 and read done signals 2020, and the control gates include ‘AND’ gates 2030 and a counting or ‘DIV’ gate 2040. The control signals and control gates enable coordinated dataflow between the configurable units of CGR processors such as compute units, memory units, and AGCUs.

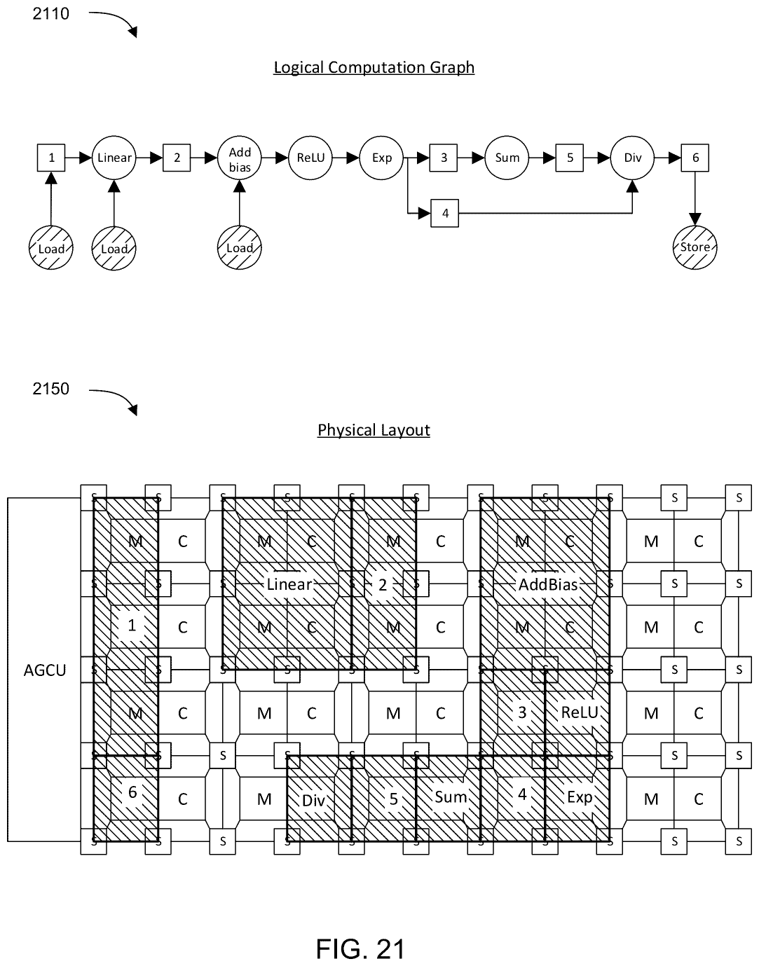

PNR 1625 translates and maps logical (i.e., unplaced physically realizable) CGR units (e.g., the nodes of the logical computation graph 2100 shown in FIG. 21) to a physical layout (e.g., the physical layout 2150 shown in FIG. 11) on the physical level, e.g., a physical array of CGR units in a semiconductor chip. PNR 1625 also determines physical data channels to enable communication among the CGR units and between the CGR units and circuits coupled via the TLN; allocates ports on the CGR units and switches; provides configuration data and initialization data for the target hardware; and produces configuration files, e.g., processor-executable format (PEF) files. It may further provide bandwidth calculations, allocate network interfaces such as AGCUs and virtual address generators (VAGs), provide configuration data that allows AGCUs and/or VAGs to perform address translation, and control ALN switches and data routing. PNR 1625 may provide its functionality in multiple steps and may include multiple modules (not shown in FIG. 16) to provide the multiple steps, e.g., a placer, a router, a port allocator, and a PEF file generator. PNR 1625 may receive its input data in various ways. For example, it may receive parts of its input data from any of the earlier modules (dataflow graph compiler 1621, algebraic graph compiler 1622, template graph compiler 1623, and/or template library 1624). In some implementations, an earlier module, such as template graph compiler 1623, may have the task of preparing all information for PNR 1625 and no other units provide PNR input data directly.

Further implementations of compiler 1620 provide for an iterative process, for example by feeding information from PNR 1625 back to an earlier module, So, that the earlier module can execute a new compilation step in which it uses physically realized results rather than estimates of or placeholders for physically realizable circuits. For example, PNR 1625 may feed information regarding the physically realized circuits back to algebraic graph compiler 1622.

Memory allocations represent the creation of logical memory spaces in on-chip and/or off-chip memories for data required to implement the dataflow graph, and these memory allocations are specified in the configuration file. Memory allocations define the type and the number of hardware circuits (functional units, storage, or connectivity components). Main memory (e.g., DRAM) may be off-chip memory, and scratchpad memory (e.g., SRAM) is on-chip memory inside a CGR array. Other memory types for which the memory allocations can be made for various access patterns and layouts include cache, read-only look-up tables (LUTs), serial memories (e.g., FIFOs), and register files.

Compiler 1620 binds memory allocations to unplaced memory units and binds operations specified by operation nodes in the dataflow graph to unplaced compute units, and these bindings may be specified in the configuration data. In some implementations, compiler 1620 partitions parts of a dataflow graph into memory subgraphs and compute subgraphs, and specifies these subgraphs in the PEF file. A memory subgraph may comprise address calculations leading up to a memory access. A compute subgraph may comprise all other operations in the parent graph. In one implementation, a parent graph is broken up into multiple memory subgraphs and exactly one compute subgraph. A single parent graph can produce one or more memory subgraphs, depending on how many memory accesses exist in the original loop body. In cases where the same memory addressing logic is shared across multiple memory accesses, address calculation may be duplicated to create multiple memory subgraphs from the same parent graph.

Compiler 1620 generates the configuration files with configuration data (e.g., a bit stream) for the placed positions and the routed data and control networks. In one implementation, this includes assigning coordinates and communication resources of the physical CGR units by placing and routing unplaced units onto the array of CGR units while maximizing bandwidth and minimizing latency.

FIG. 21 shows the logical computation graph 2100 and an example physical layout 2150 of the user program.

A first example of accelerated deep learning is using a deep learning accelerator implemented in a CGRA to train a neural network. A second example of accelerated deep learning is using the deep learning accelerator to operate a trained neural network to perform inferences. A third example of accelerated deep learning is using the deep learning accelerator to train a neural network and subsequently perform inference with any one or more of the trained neural network, information from the trained neural network, and a variant of the same.

Examples of neural networks include fully connected neural networks (FCNNs), recurrent neural networks (RNNs), graph neural networks (GNNs), convolutional neural networks (CNNs), graph convolutional networks (GCNs), long short-term memory (LSTM) networks, autoencoders, deep belief networks, and generative adversarial networks (GANs).

An example of training a neural network is determining one or more weights associated with the neural network, such as by back-propagation in a deep learning accelerator. An example of making an inference is using a trained neural network to compute results by processing input data using the weights associated with the trained neural network. As used herein, the term ‘weight’ is an example of a ‘parameter’ as used in various forms of neural network processing. For example, some neural network learning is directed to determining parameters (e.g., through back-propagation) that are usable for performing neural network inferences.

A neural network processes data according to a dataflow graph comprising layers of neurons. Example layers of neurons include input layers, hidden layers, and output layers. Stimuli (e.g., input data) are received by an input layer of neurons and the computed results of the dataflow graph (e.g., output data) are provided by an output layer of neurons. Example hidden layers include rectified linear unit (ReLU) layers, fully connected layers, recurrent layers, graphical network layers, long short-term memory layers, convolutional layers, kernel layers, dropout layers, and pooling layers. A neural network may be conditionally and/or selectively trained. After being trained, a neural network may be conditionally and/or selectively used for inference.

Examples of ICs, or parts of ICs, that may be used as deep learning accelerators, are processors such as central processing unit (CPUs), CGR processor ICs, graphics processing units (GPUS), FPGAS, ASICs, application-specific instruction-set processor (ASIP), and digital signal processors (DSPs). The disclosed technology implements efficient distributed computing by allowing an array of accelerators (e.g., reconfigurable processors) attached to separate hosts to directly communicate with each other via buffers.

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the implementations described herein.

Although the description has been described with respect to particular implementations thereof, these particular implementations are merely illustrative, and not restrictive. The description may reference specific structural implementations and methods, and does not intend to limit the technology to the specifically disclosed implementations and methods. The technology may be practiced using other features, elements, methods and implementations. Implementations are described to illustrate the present technology, not to limit its scope, which is defined by the claims. Those of ordinary skill in the art recognize a variety of equivalent variations on the description above.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although the description has been described with respect to particular implementations thereof, these particular implementations are merely illustrative, and not restrictive. For instance, many of the operations can be implemented in a CGRA system, a System-on-Chip (SoC), application-specific integrated circuit (ASIC), programmable processor, in a programmable logic device such as a field-programmable gate array (FPGA) or a graphics processing unit (GPU), obviating a need for at least part of the dedicated hardware. Implementations may be as a single chip, or as a multi-chip module (MCM) packaging multiple semiconductor dies in a single package. All such variations and modifications are to be considered within the ambit of the present disclosed technology the nature of which is to be determined from the foregoing description.

One or more implementations of the technology or elements thereof can be implemented in the form of a computer product, including a non-transitory computer-readable storage medium with computer usable program code for performing any indicated method steps and/or any configuration file for one or more CGR processors to execute a high-level program. Furthermore, one or more implementations of the technology or elements thereof can be implemented in the form of an apparatus including a memory and at least one processor that is coupled to the memory and operative to perform exemplary method steps, and/or a CGR processor that is operative to execute a high-level program based on a configuration file. Yet further, in another aspect, one or more implementations of the technology or elements thereof can be implemented in the form of means for carrying out one or more of the method steps described herein and/or executing a high-level program described herein. Such means can include (i) hardware module(s); (ii) software module(s) executing on one or more hardware processors; (iii) bit files for configuration of a CGR array; or (iv) a combination of aforementioned items.

FIGS. 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, and 54 show various implementations of the technology disclosed.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit of the technology disclosed.

1. A system, comprising:
a tool for providing actionable insight for bring up and performance debug of performant dataflow graphs on CGRA.

2. A system, comprising:
a tool for providing hierarchical traceable graph transformation of dataflow graph and annotated with runtime information after the compilation and execution back onto higher levels of stack from hardware metrics.

3. A system, comprising:
A tool for system performance monitoring and tuning by composition of compile time and runtime information of a workload dataflow graph on CGRA with one or more of the following steps:
a). intelligent combining of hardware performance counters and software compiler techniques for expert inspection and tuning of dataflow workflows via collated reports.
b). identifying and classifying possible performance bottlenecks based on ML classifiers based on the Decision Tree method. The classifiers will be trained by processed data and thresholds from compile artifact, benchmarking, and instrumentation reports of well-tuned models. This would take advantage of experienced performance engineers' efforts and provide another perspective for optimizing performance.
c). semi-automated recommendation engine to tune performance of dataflow workload by specific design rule checks to be met or violated and corresponding mitigation strategies; and provide iterated workflow for progressive performance tuning.
d). Identifying bottlenecks in workload using compile-time+runtime measurements for zero-down debug and bring up of performant dataflow workloads on CGRA.

4. The system of claim 3, further comprising semi-automated recommendation engine to tune performance of dataflow workload by specific design rule checks to be met or violated and corresponding mitigation strategies; and provide iterated workflow for progressive performance tuning.

5. The system of claim 3, further comprising performance debugger and design rule checker with capability to perform online analysis of workloads and provide automated recommendations as reports.

6. The system of claim 3, further comprising capability to plug in various analysis tools using compiler and runtime tools to publish the performance debugging reports.

7. The system of claim 3, further comprising performance debug tool work with actual hardware and compiler or simulated partial hardware from RTL and compiler.
